(19) United States
(12) Patent Application Publication
(10) Pub. No.: US 2025/0319831 A1
(43) Pub. Date: Oct. 16, 2025

(54) ONBOARD DEVICE, DATA PROVISION SYSTEM, DATA PROVISION METHOD, AND STORAGE MEDIUM STORING PROGRAM

(71) Applicant: DENSO CORPORATION, Kariya-city (JP)

(72) Inventor: Motoki SATO, Kariya-city (JP)

(21) Appl. No.: 19/247,541

(22) Filed: Jun. 24, 2025

Related U.S. Application Data
(63) Continuation of application No. PCT/JP2023/044860, filed on Dec. 14, 2023.

(30) Foreign Application Priority Data
Dec. 28, 2022 (JP) 2022-212067

(51) Int. Cl. B60R 16/023; G06F 9/445; G06F 16/25; G07C 5/00; G07C 5/04

(52) U.S. Cl. CPC B60R 16/0232; G06F 9/44505; G06F 16/258; G07C 5/008; G07C 5/04

(57) ABSTRACT

An onboard device is configured to execute a transmission process to transmit a command to a vehicle network of a vehicle equipped with the onboard device according to an instruction manual indicating one or more types of standard vehicle data, which are standardized vehicle data, and obtain specific vehicle data, which is vehicle data indicated in a format unique to a vehicle, from the vehicle network; convert the obtained specific vehicle data into a format of the standard vehicle data and store the standard vehicle data; and execute one or more application programs that utilize the standard vehicle data, and includes an API group, which is a collection of application programming interfaces prepared for each of the standard vehicle data, configured to provide a function to obtain the standard vehicle data for the one or more application programs.

### CROSS REFERENCE TO RELATED APPLICATION

The present application is a continuation application of International Patent Application No. PCT/JP2023/044860 filed on Dec. 14, 2023 which designated the U.S. and claims the benefit of priority from Japanese Patent Application No. 2022-212067 filed on Dec. 28, 2022. The entire disclosures of all of the above applications are incorporated herein by reference.

### TECHNICAL FIELD

The present disclosure relates to a technology for providing vehicle data to application programs operating in an onboard device connected to a vehicle network.

### BACKGROUND

A related art describes a device that performs diagnostic communication using data transmitted and received between ECUs via a vehicle network such as CAN, to conduct fault diagnosis. CAN is a registered trademark. In diagnostic communication, a diagnostic tester is connected to a dedicated connector such as an OBD port provided in the vehicle. The diagnostic tester transmits a request message to the ECU. The ECU replies with a response message. OBD stands for on-board diagnostic.

### SUMMARY

According to an aspect of the present disclosure, an onboard device is configured to execute a transmission process to transmit a command to a vehicle network of a vehicle equipped with the onboard device according to an instruction manual indicating one or more types of standard vehicle data, which are standardized vehicle data, and obtain specific vehicle data, which is vehicle data indicated in a format unique to a vehicle, from the vehicle network; convert the obtained specific vehicle data into a format of the standard vehicle data and store the standard vehicle data; and execute one or more application programs that utilize the standard vehicle data, and includes an application programming interface (API) group, which is a collection of application programming interfaces prepared for each of the standard vehicle data, configured to provide a function to obtain the standard vehicle data for the one or more application programs.

### BRIEF DESCRIPTION OF DRAWINGS

Objects, features and advantages of the present disclosure will become more apparent from the following detailed description made with reference to the accompanying drawings. In the drawings:

FIG. 1 is a block diagram showing a functional configuration of a data provision system;

FIG. 2 is a block diagram showing a hardware configuration of a cloud server;

FIG. 3 is a block diagram showing a hardware configuration of an onboard device;

FIG. 4 is an explanatory diagram showing a structure of a manifest;

FIG. 5 is an explanatory diagram showing a structure of a standard vehicle data instruction manual;

FIG. 6 is an explanatory diagram showing a structure of the data stored in a standard vehicle data database;

FIG. 7 is an explanatory diagram showing a structure of a command management table based on the manifest;

FIG. 8 is an explanatory diagram showing a structure of a command management table based on the standard vehicle data instruction manual;

FIG. 9 is a sequence diagram showing an operation of each part of the system when the onboard device is powered on;

FIG. 10 is a sequence diagram showing an operation during turnaround time measurement;

FIG. 11 is a sequence diagram showing an operation when updating the standard vehicle data instruction manual;

FIG. 12 is a sequence diagram showing an operation during the distribution of a diagnostic application;

FIG. 13 is a sequence diagram showing an operation when transmitting a diagnostic command;

FIG. 14 is a sequence diagram showing an operation when receiving a response to a diagnostic command;

FIG. 15 is a sequence diagram showing an operation when using the standard vehicle data database;

FIG. 16 is a flowchart showing the content of a schedule adjustment process;

FIG. 17 is an explanatory diagram illustrating requests for diagnostic commands extracted at each tick;

FIG. 18 is an explanatory diagram showing an operation when requests for diagnostic commands overlap;

FIG. 19 is an explanatory diagram showing an operation when there is a possibility of CAN bus overload;

FIG. 20A is an explanatory diagram regarding a method of transmitting commands;

FIG. 20B is an explanatory diagram regarding a method of transmitting commands; and

FIG. 21 is an explanatory diagram showing an example of setting a transmission schedule to prevent diagnostic commands from concentrating on the same tick.

### DETAILED DESCRIPTION

As a result of detailed studies by the inventor, the following difficulties have been identified. Specifically, the number of diagnostic communication ports installed in a vehicle is usually one, and a single diagnostic tester is connected to the port. It has been found that the diagnostic tester can only execute one application, allowing for single-purpose and exclusive use only.

The present disclosure provides a technology that enables simultaneous use for multiple purposes of an onboard device connected to a vehicle network.

According to one aspect of the present disclosure, an onboard device includes: a data acquisition unit configured to execute a transmission process to transmit a command to a vehicle network of a vehicle equipped with the onboard device according to an instruction manual indicating one or more types of standard vehicle data, which are standardized vehicle data, and obtain specific vehicle data, which is vehicle data indicated in a format unique to a vehicle, from the vehicle network; a standard vehicle data storage unit configured to convert the specific vehicle data obtained by the data acquisition unit into a format of the standard vehicle data and store the standard vehicle data; an application execution unit configured to execute one or more application programs that utilize the standard vehicle data; and an application programming interface (API) group, which is a collection of application programming interfaces prepared for each of the standard vehicle data, configured to provide a function to obtain the standard vehicle data from the standard vehicle data storage unit for the one or more application programs executed by the application execution unit.

According to this configuration, the vehicle data obtained via the vehicle network and accumulated in the standard vehicle data storage unit in the format of the standard vehicle data is provided to the application programs via the API group. Therefore, the onboard device can simultaneously mount and operate multiple applications with different purposes.

One embodiment of the present disclosure is a data provision system. The data provision system includes one or more onboard devices and a server. The server is provided outside the vehicle equipped with the onboard device. The onboard device includes the aforementioned configuration. The server includes a digital twin database that stores at least one of the standard vehicle data transmitted from each of the onboard devices and the digital twin data emulating the vehicle equipped with the onboard device generated based on the standard vehicle data.

According to such a configuration, the same effects as those of the aforementioned onboard device can be achieved.

One aspect of the present disclosure is a data provision method for providing vehicle data obtained via a vehicle network of a vehicle equipped with an onboard device to one or more application programs arranged in the onboard device. In this method, a transmission process is executed according to an instruction manual indicating one or more types of standard vehicle data, which are standardized vehicle data. The transmission process involves transmitting commands to the vehicle network to obtain specific vehicle data, which is vehicle data indicated in a format unique to the vehicle, from the vehicle network. Additionally, in this method, the specific vehicle data obtained by executing the transmission process is converted into the format of the standard vehicle data and stored in the standard vehicle data storage unit. Furthermore, in this method, the standard vehicle data is provided to the application programs by an API group, which is a collection of application programming interfaces prepared for each of the standard vehicle data to provide a function to obtain the standard vehicle data from the standard vehicle data storage unit.

According to such a method, the same effects as those of the aforementioned onboard device can be achieved.

One aspect of the present disclosure is a program. The program is executed to provide vehicle data obtained via a vehicle network of a vehicle equipped with an onboard device to one or more application programs arranged in the onboard device.

The program causes the onboard device to execute a transmission process. The transmission process involves transmitting commands to the vehicle network according to an instruction manual indicating one or more types of standard vehicle data, which are standardized vehicle data, to obtain specific vehicle data indicated in a format unique to the vehicle from the vehicle network.

The program causes the onboard device to convert the specific vehicle data obtained by executing the transmission process into the format of the standard vehicle data and store it in the standard vehicle data storage unit.

The program causes the onboard device to provide the standard vehicle data to the application programs by an API group, which is a collection of application programming interfaces prepared for each of the standard vehicle data to provide a function to obtain the standard vehicle data from the standard vehicle data storage unit.

By executing such a program, the same effects as those of the aforementioned onboard device can be achieved.

Embodiments of the present disclosure will be described with reference to the drawings.

### 1. Configuration

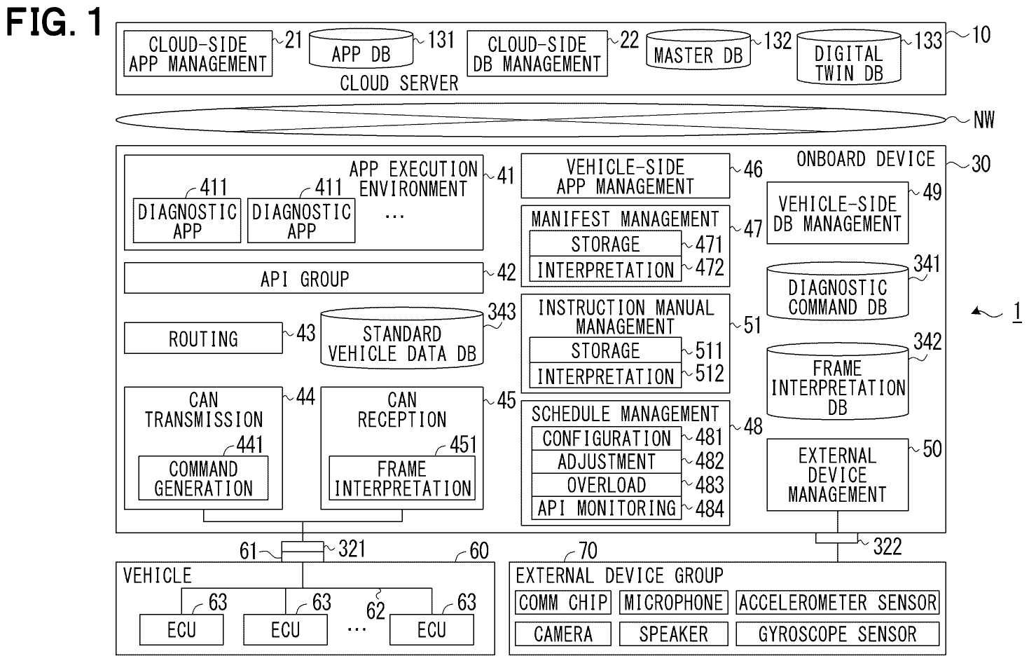

The data provision system 1 shown in FIG. 1 includes a cloud server 10 and an onboard device 30 (also referred to as an on-vehicle machine, or a vehicle-mounted device). In FIG. 1, one cloud server 10 and one onboard device 30 are illustratively shown. The data provision system 1 may have multiple cloud servers 10 and multiple onboard devices 30.

### (1-1. Cloud Server)

The cloud server 10 is configured to be accessible via a wide-area communication network NW. The cloud server 10 distributes various information necessary for executing diagnostic application programs (also referred to as diagnostic system applications or diagnostic related applications) to the onboard device 30. Diagnostic applications are applications that utilize vehicle data collected through diagnostic communication. Diagnostic communication is a communication method that uses the vehicle network to obtain vehicle data necessary for fault diagnosis from the electronic control unit (also referred to as ECU) 63. In this embodiment, the vehicle network used is the CAN bus 62. CAN stands for Controller Area Network, and is a registered trademark.

Vehicle data is classified into multiple data types. The data types may include “vehicle body control and powertrain systems,” “AD/ADAS systems,” “driver monitoring systems,” “vehicle body systems,” “interior/exterior environment control systems,” “fuel/exhaust systems,” “media systems,” and “diagnostic trouble codes (DTC).”

Vehicle data for vehicle body control and powertrain systems may include vehicle speed, vehicle body acceleration (also referred to as vehicle acceleration), vehicle body angular velocity (also referred to as vehicle angular velocity), gear position, accelerator pedal position, brake pedal position, brake pressure or the like.

Vehicle data for AD/ADAS systems may include inter-vehicle distance, speed limit signs, stop sign detection, lane-keeping warnings, preceding vehicle following, clearance sonar, obstacle detection or the like.

Vehicle data for driver monitoring systems may include distracted driving detection status, attention decline detection status, driver abnormality detection status or the like.

Vehicle data for vehicle body systems may include total mileage (i.e., odometer value), Global Positioning System (also referred to as GPS) location information, light on/off status, door/window open/close status, door/window lock status, seat belt status, airbag status, tire pressure, air conditioner operation status, parking brake status or the like.

Vehicle data for interior/exterior environment control systems may include interior/exterior temperature, air conditioner operation status or the like.

Vehicle data for fuel/exhaust systems may include battery charge status, fuel tank capacity, remaining fuel amount, average fuel consumption amount or the like.

Vehicle data for media systems may include media usage status, volume, Bluetooth (also referred to as BT) connection status, Data Communication Module (also referred to as DCM) connection status or the like. Bluetooth is a registered trademark.

Vehicle data for DTC may include a DTC list or the like.

Vehicle data may have priorities set according to the data types. The priorities may be set, for example, as follows. However, the priority setting according to the data types is not limited to the following order and can be set arbitrarily.

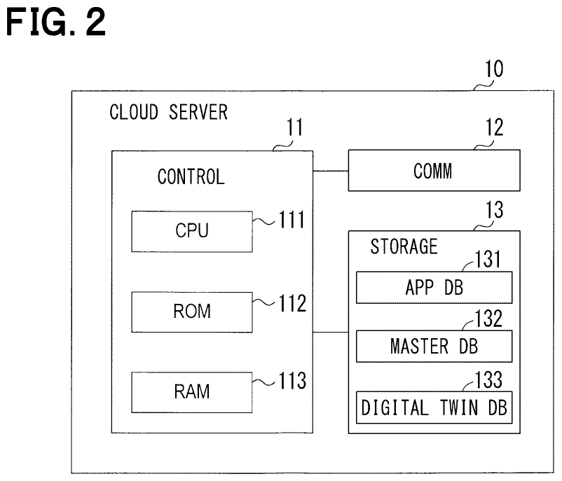

Vehicle body control and powertrain systems>AD/ADAS systems>driver monitoring systems>vehicle body systems>interior/exterior environment control systems>fuel/exhaust systems>media systems>DTC. As shown in FIG. 2, the cloud server 10 includes a control unit 11, a communication unit 12, and a storage unit 13.

The control unit 11 includes a CPU 111, a ROM 112, and a RAM 113. Various functions of the control unit 11 are realized by the CPU 111 executing programs stored in a non-transitory tangible recording medium. In this example, the ROM 112 corresponds to the non-transitory tangible recording medium storing programs. By executing these programs, methods corresponding to the programs are executed.

The communication unit 12 performs data communication with the onboard device 30 via wireless communication through the wide-area communication network NW.

The storage unit 13 includes an application database (also referred to as an application DB) 131, a master database (also referred to as a master DB) 132, and a digital twin database (also referred to as a digital twin DB) 133. The application DB 131 stores information related to one or more diagnostic applications. The master DB 132 stores information related to the CAN bus 62 of the vehicle 60 to which the onboard device 30 is connected. The digital twin DB 133 stores information necessary for generating a digital twin, which is a technology that reproduces the state and movement of an actual vehicle in a virtual space.

### (1-2. Onboard Device)

As shown in FIG. 1, the onboard device 30 is used by connecting to the diagnostic port 61 provided in the vehicle 60. The onboard device 30 downloads and executes one or more diagnostic applications 411 from the cloud server 10.

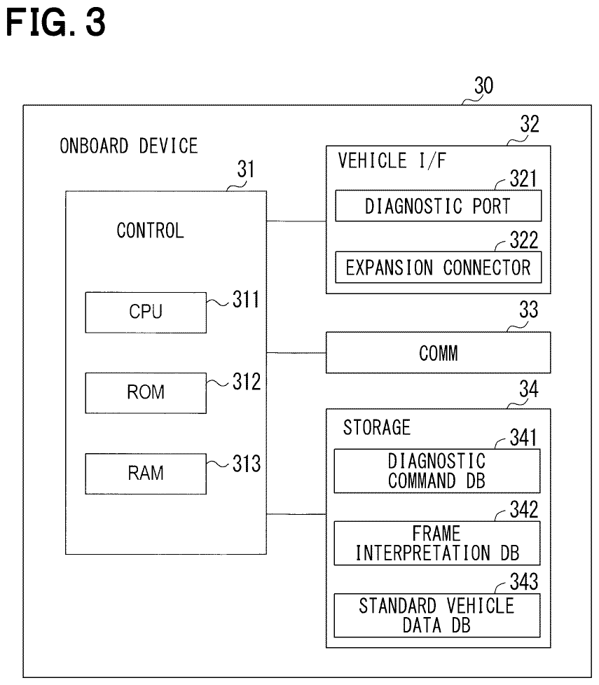

As shown in FIG. 3, the onboard device 30 includes a control unit 31, a vehicle interface (also referred to as a vehicle I/F) 32, a communication unit 33, and a storage unit 34.

The control unit 31 includes a CPU 311, a ROM 312, and a RAM 313. Various functions of the control unit 31 are realized by the CPU 311 executing programs stored in a non-transitory tangible recording medium. In this embodiment, the ROM 312 corresponds to the non-transitory tangible recording medium storing the programs. By executing these programs, methods corresponding to the programs are executed.

The vehicle I/F 32 includes a diagnostic connector 321 and an expansion connector 322.

As shown in FIG. 1, the diagnostic connector 321 is connected to the diagnostic port 61 (for example, an OBD port) provided in the vehicle 60. In other words, the onboard device 30 is connected to the CAN bus 62 of the vehicle 60 via the diagnostic port 61 connected to the diagnostic connector 321. The onboard device 30 obtains various vehicle data held by the ECU 63 via diagnostic communication using the CAN bus 62.

The expansion connector 322 receives signals from external device group 70 retrofitted to the vehicle. The external device group 70 may include communication chips (for example, BLE, LTE, NFC or the like), cameras, microphones, speakers, acceleration sensors, gyroscope sensors or the like. BLE stands for Bluetooth Low Energy. LTE stands for Long Term Evolution. NFC stands for Near Field Communication.

Returning to FIG. 3, the communication unit 33 performs data communication with the cloud server 10 connected to the wide-area communication network NW via wireless communication.

The storage unit 34 includes a diagnostic command database (also referred to as a diagnostic command DB) 341 and a frame interpretation database (also referred to as a frame interpretation DB) 342.

The diagnostic command DB 341 stores diagnostic command information obtained from the cloud server 10 via the communication unit 33. The frame interpretation DB 342 stores frame interpretation information and normalization rules obtained from the cloud server 10 via the communication unit 33. The diagnostic command information, frame interpretation information, and normalization rules will be described later.

### 2. Functional Configuration

The functional configuration of the cloud server 10 and the onboard device 30 will be described.

### (2-1. Cloud Server)

As shown in FIG. 1, the cloud server 10 includes an application DB 131, a master DB 132, and a digital twin DB 133. The application DB 131, master DB 132, and digital twin DB 133 are configured on the storage unit 13.

The application DB 131 stores one or more diagnostic applications to be distributed to the onboard device 30 and manifests corresponding to each diagnostic application.

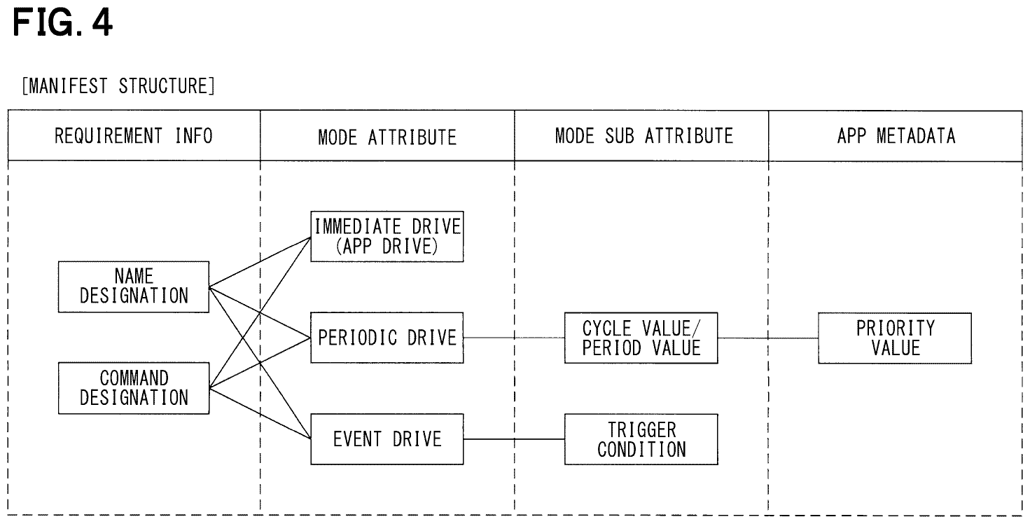

The manifest is an instruction manual that describes the types of vehicle data used by one or more diagnostic system applications and the acquisition conditions for each vehicle data. That is, the manifest is an instruction manual that describes, in correspondence, the types of each vehicle data and the acquisition conditions and the like for each vehicle data, for one or more vehicle data used in the diagnostic system application. The manifest is created by the application developer. The manifest is written in a format that can be understood even if the application developer does not have specialized knowledge about vehicles. Specifically, as shown in FIG. 4, the manifest includes “request information” and “mode attribute.” Additionally, the manifest may include “mode sub-attribute” and “application metadata” depending on the content of the “mode attribute.”

“Request information” specifies the type of vehicle data. When specifying the type of vehicle data, both name designation and command designation can be used. Name designation is a method of specifying vehicle data with standardized names that can be intuitively understood, defined commonly regardless of vehicle type. The vehicle data that can be specified by name designation is also referred to as standard vehicle data. Command designation is a method of specifying vehicle data in the format (i.e., bit pattern) actually transmitted and received in vehicle diagnostic communication, defined uniquely for each vehicle type. The same vehicle data may be set to be specified by either name designation or command designation.

The “mode attribute” specifies how to obtain the vehicle data indicated in the “request information.” The “mode attribute” include an application drive, a periodic drive, and an event drive. The application drive is a mode used when acquiring the specified vehicle data at a limited number of times within a limited time according to instructions from the diagnostic application. Immediate drive refers to acquiring the data only once immediately, which is a type of the application drive. In this embodiment, the immediate drive as an example of the application drive will be described. The periodic drive is a mode used when repeatedly acquiring specified vehicle data at a specified constant period. The event drive is a mode used when acquiring specified vehicle data triggered by a change in signals detected upon the occurrence of specified events. The application drive, the periodic drive, the event drive, and the immediate drive and the like may be referred to as an application-driven mode, a periodic-driven mode, an event-driven mode, and an immediate-driven mode and the like, respectively.

The “mode sub-attribute” varies depending on the type of the “mode attribute” and are set as needed. If the “mode attribute” is the immediate drive, there may be no information set as the “mode sub-attribute.” If the “mode attribute” are the periodic drive, the “mode sub-attribute” may include a period value representing the acquisition period of the vehicle data and a duration value representing the acquisition duration of the vehicle data. If the “mode attribute” are the event drive, the “mode sub-attribute” may include a trigger condition. The trigger condition defines which signal state triggers the acquisition. The trigger condition may utilize information obtained via the CAN bus 62, signals from the external device group 70, and information obtained by processing signals from the external device group 70 (e.g., differentiation, integration, smoothing).

“Application metadata” may include a priority value representing the priority of the vehicle data. The priority of vehicle data is used to determine which vehicle data acquisition to prioritize when multiple vehicle data acquisitions are requested simultaneously, and it is difficult to process all requests.

The master DB 132 stores diagnostic command information, frame interpretation information, normalization rules, and a standard vehicle data instruction manual.

Frame interpretation information defines the format of communication frames used on the CAN bus 62, the bit assignments in each area of the frame, and the units of values indicated in the assigned areas. Frame interpretation information is prepared for each vehicle model and is necessary for interpreting the communication frames used in diagnostic communication.

Normalization rules are information that shows the rules used to convert specific vehicle data, represented in a format unique to the vehicle 60 extracted from communication frames, into the format of standard vehicle data. Like frame interpretation information, normalization rules are prepared for each vehicle model.

Diagnostic command information includes a list of diagnostic commands usable on the CAN bus 62. The diagnostic command information contains information related to both name designation and command designation as described in the “request information” of the manifest. The diagnostic command information, like frame interpretation information and normalization rules, is prepared for each vehicle model.

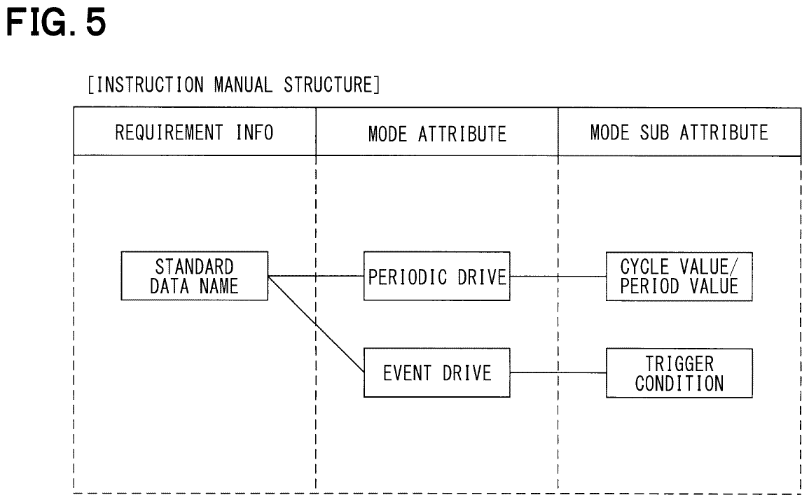

The standard vehicle data instruction manual is an instruction manual that describes the types of standardized vehicle data, which are standard vehicle data used commonly across all vehicle models, and the acquisition condition for each standard vehicle data. The standard vehicle data instruction manual is created by, for example, a provider offering the infrastructure for digital twins. As shown in FIG. 5, the standard vehicle data instruction manual essentially has the same content as the manifest. Specifically, the standard vehicle data instruction manual includes “request information” and the “mode attribute.” Additionally, the standard vehicle data instruction manual may include the “mode sub-attribute” depending on the content of the “mode attribute.”

“Request information” specifies the name of the standard vehicle data, that is, it is specified by standardized names. This is the same as the name designation in the manifest. The “mode attribute” includes the periodic drive and the event drive. In other words, compared to the manifest, the immediate drive is omitted. The content of the “mode sub-attribute” is the same as in the manifest.

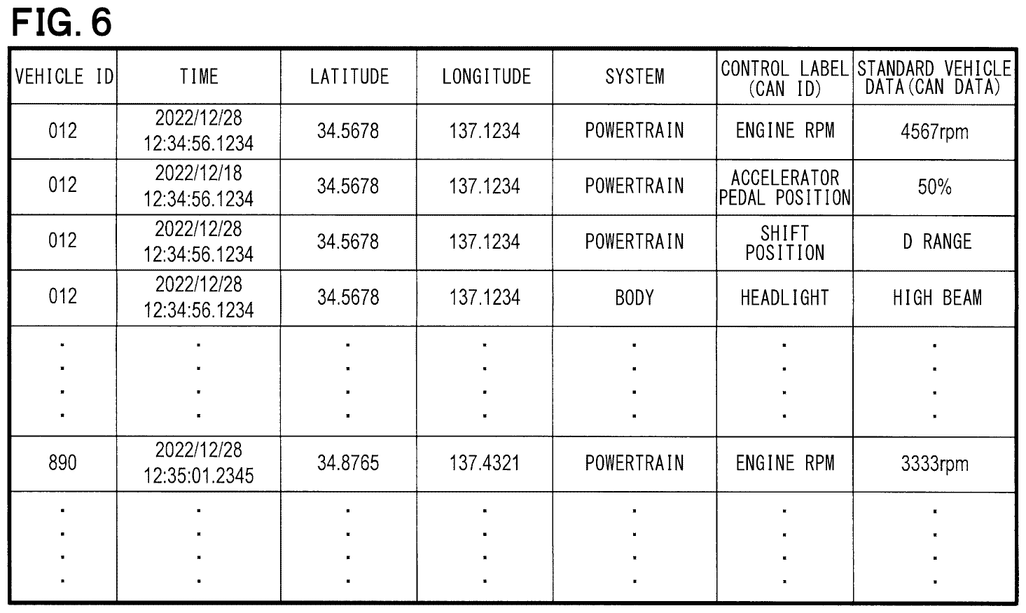

The digital twin DB 133 accumulates standard vehicle data repeatedly provided from multiple vehicles. As shown in FIG. 6, standard vehicle data is stored in association with vehicle ID, time, latitude, longitude, system, and a control label.

The vehicle ID is information that identifies the vehicle (also referred to as a source vehicle) that provided the standard vehicle data. The vehicle ID may be, for example, the VIN (a vehicle identification number) or a number uniquely defined by the system in association with the VIN.

The time represents the date and time when the vehicle information was obtained by the source vehicle.

Latitude and longitude represent the position of the source vehicle at the time the vehicle information was obtained.

The system is information that identifies the CAN from which the vehicle information was sourced in the source vehicle. In other words, when the in-vehicle network is divided into multiple CANs by function, such as powertrain CAN and body CAN, the system specifies from which CAN the information was obtained.

The control label is a label that indicates the name of the vehicle data specified from the CAN ID shown in the CAN frame.

The vehicle data is information that has been converted from the vehicle data indicated in the CAN data to the format of standard vehicle data.

The digital twin DB 133 accumulates standard vehicle data transmitted from multiple onboard devices 30, as well as digital twin data generated by processing the standard vehicle data to emulate the vehicle 60 equipped with the onboard device 30.

The cloud server 10 includes a cloud-side application management unit 21 and a cloud-side DB management unit 22 as functions realized by the processing executed by the control unit 11.

The cloud-side application management unit 21 executes the distribution and deletion of diagnostic applications to the onboard device 30, and monitors the operation of the distributed diagnostic applications. The cloud-side application management unit 21 assigns and manages application IDs to the diagnostic applications stored in the application DB 131 and the manifests associated with the diagnostic applications. The cloud-side application management unit 21 may manage a diagnostic application in association with a business entity that developed it.

The cloud-side DB management unit 22 executes the distribution of diagnostic command information, frame interpretation information, normalization rules, and a standard vehicle data instruction manual stored in the master DB 132 in response to requests from the onboard device 30. The cloud-side DB management unit 22 may autonomously distribute update information to each onboard device 30 when the content of the master DB 132 is updated. The cloud-side DB management unit 22 stores the obtained data transmitted from multiple onboard devices 30 in the digital twin DB 133 and executes processes such as searching for data in response to requests. The cloud-side DB management unit 22 may be configured to identify the vehicle model from the vehicle identification number (VIN).

### (2-2. Onboard Device)

The onboard device 30 includes a diagnostic command DB 341, a frame interpretation DB 342, and a standard vehicle data DB 343. The diagnostic command DB 341, the frame interpretation DB 342, and the standard vehicle data DB 343 are configured on the storage unit 34.

The diagnostic command DB 341 stores diagnostic command information applicable to a vehicle model of the vehicle 60 (referred to as a mounted vehicle) to which the onboard device 30 is attached.

The frame interpretation DB 342 stores frame interpretation information that is applicable to the vehicle model of the mounted vehicle 60.

The standard vehicle data DB 343 stores the standard vehicle data obtained from the mounted vehicle 60. The standard vehicle data is stored in the standard vehicle data DB 343 in a format that omits the vehicle ID from the accumulated data shown in the digital twin DB 133 in FIG. 6.

The onboard device 30 includes functions realized by the processing executed by the control unit 31, such as an application execution environment 41, API group 42, a routing unit 43, a CAN transmission unit 44, a CAN reception unit 45, a vehicle-side application management unit 46, a manifest management unit 47, an instruction manual management unit 51, a schedule management unit 48, a vehicle-side DB management unit 49, and an external device management unit 50.

The external device management unit 50 manages the external device group 70 connected to the expansion connector 322 of the onboard device 30. The external device management unit 50 monitors signals input from each external device belonging to the external device group 70. The external device management unit 50 has the function of notifying the schedule management unit 48 of the occurrence of an event when the monitored signals satisfy the trigger condition notified by the schedule management unit 48. The external device management unit 50 may also have the function of notifying the schedule management unit 48 of a hardware configuration change when it detects a change in the external device group 70 connected to the expansion connector 322 compared to the previous startup when the onboard device 30 is started.

The vehicle-side DB management unit 49 obtains diagnostic command information, frame interpretation information, and normalization rules suitable for the mounted vehicle 60 from the cloud server 10 when the onboard device 30 is initially connected to the mounted vehicle 60. The vehicle-side DB management unit 49 stores the obtained diagnostic command information in the diagnostic command DB 341 and the frame interpretation information and normalization rules in the frame interpretation DB 342. The vehicle-side DB management unit 49 has the function of acquiring the standard vehicle data instruction manual either simultaneously with the diagnostic command information, frame interpretation information and normalization rules, or according to instructions from the cloud server 10. The vehicle-side DB management unit 49 provides the obtained standard vehicle data instruction manual to the instruction manual management unit 51. The vehicle-side DB management unit 49 has the function of periodically and autonomously or according to instructions from the cloud server 10, uploading the standard vehicle data stored in the standard vehicle data DB 343 along with the vehicle ID assigned to the mounted vehicle 60 to the digital twin DB 133 of the cloud server 10.

The application execution environment 41 includes an OS and middleware. The application execution environment 41 provides an execution environment for diagnostic applications distributed from the cloud server 10.

The vehicle-side application management unit 46 obtains diagnostic applications 411 from the cloud server 10 via the wide-area communication network NW and deploys (i.e., installs and sets up) the obtained diagnostic applications 411 in the application execution environment 41. Additionally, the vehicle-side application management unit 46 monitors the operation of the deployed diagnostic applications 411 and deletes the deployed diagnostic applications 411 as needed. Furthermore, the vehicle-side application management unit 46 provides the manifest distributed from the cloud server 10 along with the diagnostic applications 411 to the manifest management unit 47. The vehicle-side application management unit 46 may have the function of notifying the schedule management unit 48 of software configuration changes each time a diagnostic application is deployed or deleted.

The API group 42 is a collection of application programming interfaces (also referred to as API) that provide various functions to the diagnostic applications 411 executed in the application execution environment 41. The API group 42 include at least one API that provides the function of acquiring vehicle data via the CAN bus 62 of the mounted vehicle 60. Additionally, the API group 42 includes at least one API (also referred to as a standard data API) that provides the function of acquiring standard vehicle data from the standard vehicle data DB 343. The standard data API is prepared individually for each standard vehicle data.

In other words, the diagnostic applications 411 can use two methods to utilize vehicle data. One method is to describe the acquisition condition in the manifest, thereby automatically receiving the vehicle data according to the conditions described in the manifest. The other method is to autonomously obtain standard vehicle data using the standard data API. The developer of the diagnostic application 411 can adopt either method.

The routing unit 43 has routing information notified by the schedule management unit 48. The routing information is information that associates the diagnostic application 411 (also referred to as a requesting application) requesting vehicle data with the diagnostic command transmitted to the CAN bus 62 according to the request. The routing unit 43 distributes the vehicle data received by the CAN reception unit 45 to the requesting application by referring to the routing information when the CAN transmission unit 44 transmits the diagnostic command.

Since CAN is a communication method that does not perform session management to identify the communication partner, it is impossible to determine which diagnostic application 411 the received frame is based on when there are multiple requesting applications. Therefore, the routing unit 43 ensures that the vehicle data obtained from the CAN bus 62 via the CAN reception unit 45 correctly reaches each requesting application by referring to the routing information that associates the requesting application with the command ID.

The manifest management unit 47 includes a storage unit 471 and an interpretation unit 472.

The storage unit 471 stores the manifest provided by the vehicle-side application management unit 46.

The interpretation unit 472 interprets the content of the manifest stored in the storage unit 471, extracts and generates the information necessary for setting the command management table, and provides it to the schedule management unit 48. Specifically, the interpretation unit 472 identifies the vehicle data from the “request information” of the manifest and extracts the command ID of the command used to obtain the identified vehicle data from the diagnostic command information. The interpretation unit 472 extracts the content of the “mode attribute” and the “mode sub-attribute” of the manifest as the acquisition condition for the vehicle data. The interpretation unit 472 extracts the content of the “application metadata” of the manifest as the priority value representing the transmission priority. Instead of using the priority value set in the “application metadata,” the interpretation unit 472 may automatically set the priority value from the “mode attribute” and the “mode sub-attribute” (i.e., the acquisition condition for the vehicle data) of the manifest, for example, as follows: “Immediate drive or event drive”<“Periodic drive: long period”<“Periodic drive: short period.”

In other words, the priority of the periodic drive commands may be set higher than that of immediate drive commands and event drive commands, and among periodic drive commands, the priority of commands with shorter periods may be set higher. However, the order of priority is not limited to the above description and can be set arbitrarily.

Additionally, the interpretation unit 472 may use priority values set according to the data type of the vehicle data identified from the “request information” of the manifest instead of using the priority values set in the “application metadata.” Furthermore, the priority values set based on the acquisition condition of the vehicle data and those set according to the data type may be combined.

The instruction manual management unit 51 includes a storage unit 511 and an interpretation unit 512.

The storage unit 511 stores the standard vehicle data instruction manual provided by the vehicle-side DB management unit 49.

The interpretation unit 512 interprets the content of the standard vehicle data instruction manual stored in the storage unit 511, extracts and generates the information necessary for setting the command management table, and provides it to the schedule management unit 48. The specific processing in the interpretation unit 512 is similar to the processing in the interpretation unit 472 for interpreting the manifest, except that the processing related to “application metadata” is omitted.

The schedule management unit 48 includes a setting unit 481, an adjustment unit 482, a load calculation unit 483, and an API monitoring unit 484.

The setting unit 481 adds management information indicating the acquisition condition of vehicle data to the command management table based on the interpretation results of the manifest by the interpretation unit 472 and the interpretation results of the standard vehicle data instruction manual by the interpretation unit 512. The command management table is a table that shows information used to manage the transmission timing of diagnostic commands.

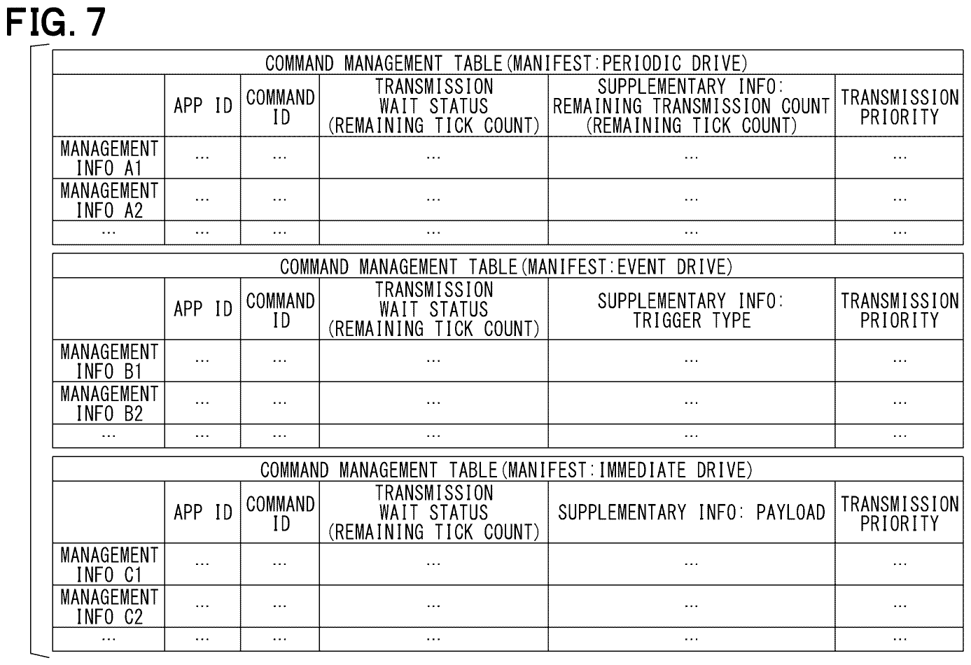

As shown in FIG. 7, the management information set in the command management table according to the interpretation results of the manifest includes “application ID,” “command ID,” “transmission wait status,” “supplementary information,” and “transmission priority.” The command management table is generated for each type of the “mode attribute,” and the content of the “supplementary information” differs for each “mode attribute.”

The “application ID” is information that identifies the requesting application, and is assigned when the diagnostic application is deployed by the vehicle-side application management unit 46.

The “command ID” is information that identifies the diagnostic command used to obtain the vehicle data indicated in the “request information” of the manifest.

The “transmission wait status” indicates the remaining tick count until transmission. A tick is the execution cycle of the diagnostic command transmission process, set to, for example, 100 ms (milliseconds). The remaining tick count is decremented with each tick, and the management information with a remaining tick count of 0 is processed in the next tick.

If the “mode attribute” is the periodic drive, the “transmission wait status” is preset to the tick count corresponding to the period value indicated in the “mode sub-attribute” each time the command transmission is executed. As a result, in the case of the periodic drive, the command transmission is repeated at a period corresponding to the period value.

If the “mode attribute” is the event drive, the “transmission wait status” is normally set to an invalid value indicating no request, and is set to 0 when the specified trigger condition is satisfied. After the command transmission, it is set back to the invalid value. The invalid value may be, for example, a value padded with all bits set to 1.

If the “mode attribute” is the immediate drive, the “transmission wait status” is normally set to an invalid value and is set to 0 when a request from the diagnostic application 411 occurs. After the command transmission, it is set back to the invalid value. When the “transmission wait status” is set to an invalid value, the decrement with each tick is not performed, and the invalid value is maintained.

If the “mode attribute” is the periodic drive, the “supplementary information” may include “remaining transmission count.” If the “mode sub-attribute” of the manifest include information on the effective period, the remaining tick count indicating the effective period is set as the “remaining transmission count.” If the effective period is unlimited, the “remaining transmission count” is set to an invalid value. The remaining tick count of the “remaining transmission count” is decremented with each tick. If it is set to an invalid value, the decrement with each tick is not performed, and the invalid value is maintained. When the tick count of the “remaining transmission count” reaches 0, the management information is deleted from the command management table.

If the “mode attribute” is the event drive, the “supplementary information” may include “trigger type.” The “trigger type” sets the trigger condition, which is the condition for notifying the occurrence of an event. The setting unit 481 notifies the external device management unit 50 and the CAN reception unit 45 of the trigger condition according to the content of the “trigger type.”

If the “mode attribute” is the immediate drive, the “supplementary information” may include “payload.” The “payload” sets the command itself in the bit format written into the CAN frame payload.

The “transmission priority” is set with a priority value. The priority value is information used to determine which diagnostic command to be prioritized when it is difficult to process all transmission candidates in the next tick due to reasons such as overload, after extracting the transmission candidate commands according to the command management table. Here, the higher the priority value, the higher the priority. The priority value uses the value extracted or set by the interpretation units 472 and 512. If the priority value is not extracted or set, it may be considered the lowest priority.

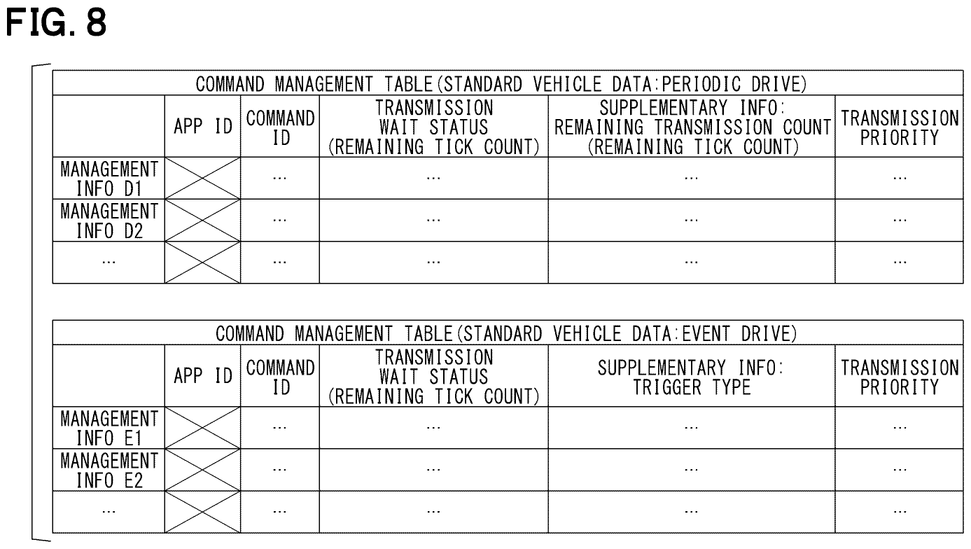

As shown in FIG. 8, the management information set in the command management table according to the interpretation results of the standard vehicle data instruction manual includes the “command ID,” the “transmission wait status,” the “supplementary information,” and the “transmission priority.” In other words, the management information based on the standard vehicle data instruction manual (also referred to as an instruction-based management information or management information based on an instruction manual) is similar to the management information based on the manifest, except that the “application ID” is omitted. The priority value representing the “transmission priority” may be set according to the monitoring results of the API monitoring unit 484.

The API monitoring unit 484 monitors the usage status of each standard data API included in the API group 42. The API monitoring unit 484 calculates the usage frequency of the standard data APIs by counting the number of accesses from the diagnostic applications 411 for each standard data API. The usage frequency may be the number of accesses per hour for the entire count period or the number of accesses within a certain past period. The API monitoring unit 484 sets and updates the priority value of the instruction-based management information according to the usage frequency of the corresponding standard data API. Specifically, the priority value of the management information is set higher as the usage frequency of the corresponding standard data API increases.

The adjustment unit 482 refers to the command management table to determine the management information to be processed in the next tick, that is, the diagnostic commands to be transmitted, and notifies the CAN transmission unit 44. The determination of the diagnostic commands to be transmitted considers the turnaround time of each diagnostic command, the traffic on the CAN bus 62, and the transmission priority of the diagnostic commands.

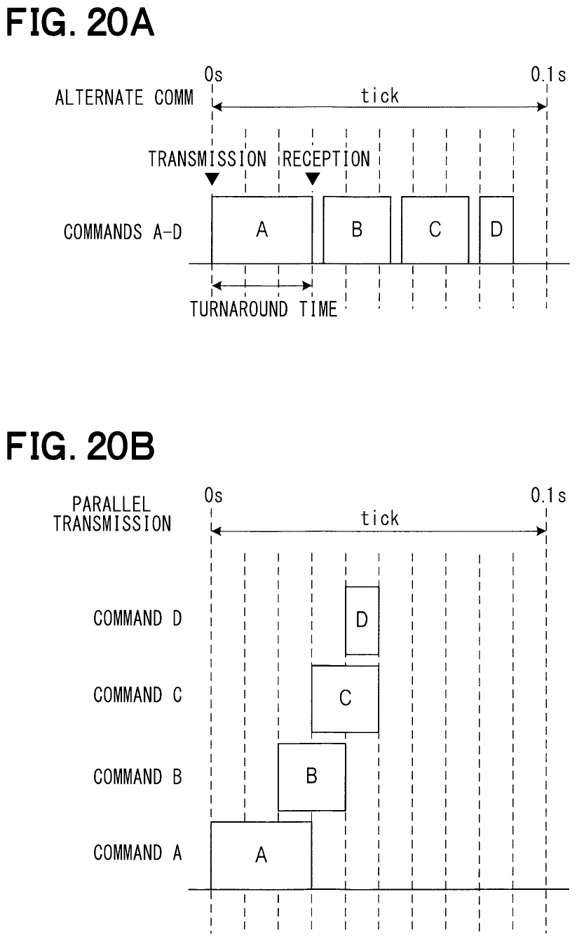

In diagnostic communication, if parallel transmission of commands is prohibited and alternate communication of commands is required, the number of commands that can be transmitted per tick can be estimated from the turnaround time. Alternating communication is a method in which, as shown in FIG. 20A, the next command is transmitted after receiving the response to the previously transmitted command. Parallel transmission is a method in which, as shown in FIG. 20B, the next command is transmitted without waiting for the response to the previously transmitted command. In FIG. 20B, a triangular symbol indicating transmission, a triangular symbol indicating reception, and a double-headed arrow indicating turnaround time are omitted. These can be referenced in FIG. 20A.

Traffic is the ratio of usage of the CAN bus 62. The higher the traffic, the longer the turnaround time, and the fewer commands can be transmitted per tick. Additionally, the upper limit of allowable traffic on the CAN bus 62 (also referred to as an allowable value) may be set for each vehicle model.

The load calculation unit 483 measures the turnaround time used in the processing of the adjustment unit 482 after the initialization process at the startup of the onboard device 30. The turnaround time measurement involves the CAN transmission unit 44 transmitting a command to the CAN bus 62 and the CAN reception unit 45 measuring the time until the response is received. This measurement is repeated for multiple commands. The load calculation unit 483 may calculate the average value of the measured turnaround times. The load calculation unit 483 stores either or both the turnaround time measured for each command and the average turnaround time in the diagnostic command DB 341.

The CAN transmission unit 44 includes a command generation unit 441. The command generation unit 441 generates diagnostic commands by referring to the diagnostic command DB 341 according to the instructions from the adjustment unit 482 of the schedule management unit 48. The command generation unit 441 further generates CAN frames with the diagnostic commands stored in the payload and stores them in the transmission buffer. The CAN transmission unit 44 transmits the CAN frames stored in the transmission buffer to the CAN bus 62 via the diagnostic connector 321.

The CAN reception unit 45 includes a frame interpretation unit 451. The CAN reception unit 45 stores the CAN frames (i.e., a response to a diagnostic command) received from the CAN bus 62 via the diagnostic connector 321 in the reception buffer. The frame interpretation unit 451 interprets the content of the received CAN frame (also referred to as a received frame) by referring to the frame interpretation information and a normalization rule stored in the frame interpretation DB 342. The frame interpretation unit 451 converts the vehicle data indicated in the payload of the received frames, described in a format unique to the vehicle 60, into the format of standard vehicle data understandable by the requesting application. The frame interpretation unit 451 not only converts CAN data into “vehicle data” but also converts the CAN ID into a “control label” representing the data type of the vehicle data indicated by the CAN data and a “system” representing the system to which the device that generated the CAN data belongs.

The CAN reception unit 45 provides the “vehicle data,” the “control label,” and the “system,” which have been interpreted and converted by the frame interpretation unit 451, to the routing unit 43 along with the “command ID” of the transmitted diagnostic command and “additional information.” The additional information includes “time,” “latitude,” and “longitude,” which are separately obtained by the CAN reception unit 45 via the external device management unit 50 or the like.

The CAN reception unit 45 has the function of monitoring vehicle data received periodically. The CAN reception unit 45 has the function of notifying the schedule management unit 48 of the occurrence of an event when the monitored signal satisfies the trigger condition notified by the schedule management unit 48. The CAN reception unit 45 has the function of measuring the turnaround time, which is the time from when a command is transmitted by the CAN transmission unit 44 until the response to that command is received by the CAN reception unit 45, and notifying the load calculation unit 483. The CAN reception unit 45 has the function of providing the received vehicle data to the routing unit 43. When the received vehicle data is standard vehicle data, the CAN reception unit 45 has the function of storing the vehicle data in the standard vehicle data DB 343 along with the control label, the system, and the additional information.

The routing unit 43 provides the vehicle data received from the CAN reception unit 45 to the requesting application according to the routing information notified by the adjustment unit 482 of the schedule management unit 48.

### 3. Operation

### (3-1. Operation at Power-On of the Onboard Device)

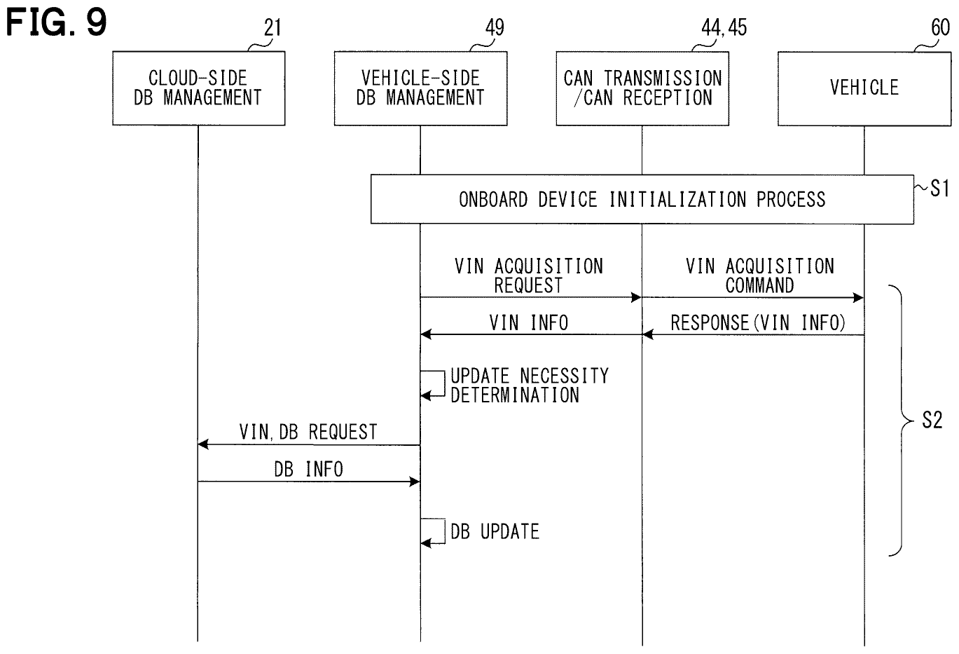

The operation of each part of the system when the onboard device 30 is powered on will be explained using the sequence diagram shown in FIG. 9.

As shown in FIG. 9, when the onboard device 30 is powered on, the onboard device 30 executes a process to initialize the onboard device 30 (also referred to as an onboard device initialization process) S1. The onboard device initialization process S1 enables the onboard device 30 to perform diagnostic communication using standard commands.

The vehicle-side DB management unit 49 transmits a VIN acquisition command, which is one of the standard commands, to the CAN bus 62 via the CAN transmission unit 44 and receives the response via the CAN reception unit 45 to obtain VIN information from the vehicle 60.

The vehicle-side DB management unit 49 determines whether to update the diagnostic command DB 341 and the frame interpretation DB 342 using the obtained VIN information. Specifically, if VIN-related information is not stored in the diagnostic command DB 341 and the frame interpretation DB 342, it is determined that an update is necessary. The VIN-related information includes diagnostic command information, frame interpretation information, and normalization rules associated with the obtained VIN information. If the VIN-related information is already stored in the diagnostic command DB 341 and the frame interpretation DB 342, it is determined that an update is not necessary.

For example, if the onboard device 30 is installed in a vehicle for the first time, it is determined that an update is necessary. Additionally, if the onboard device 30 is removed from the first vehicle 60 and installed in the second vehicle 60 while the VIN-related information of the first vehicle 60 remains in the diagnostic command DB 341 and the frame interpretation DB 342, and the VIN information of the second vehicle 60 is obtained, it is determined that an update is necessary.

If it is determined that an update is not necessary, the vehicle-side DB management unit 49 terminates the operation.

If it is determined that an update is necessary, the vehicle-side DB management unit 49 transmits a data acquisition request to the cloud server 10 along with the obtained VIN information to obtain VIN-related information corresponding to the vehicle model of the mounted vehicle 60 from the cloud server 10. At this time, the cloud-side DB management unit 22 of the cloud server 10 identifies the vehicle model from the VIN information indicated in the data acquisition request, reads the VIN-related information corresponding to the identified vehicle model from the master DB 132, and replies to the onboard device 30.

The vehicle-side DB management unit 49 updates the diagnostic command DB 341 and the frame interpretation DB 342 with the VIN-related information received from the cloud server 10. The updated VIN-related information is stored in association with the VIN information.

The series of processes executed after the onboard device initialization process S1 described using FIG. 9 is also referred to as the database update process S2.

### (3-2. Turnaround Time Measurement)

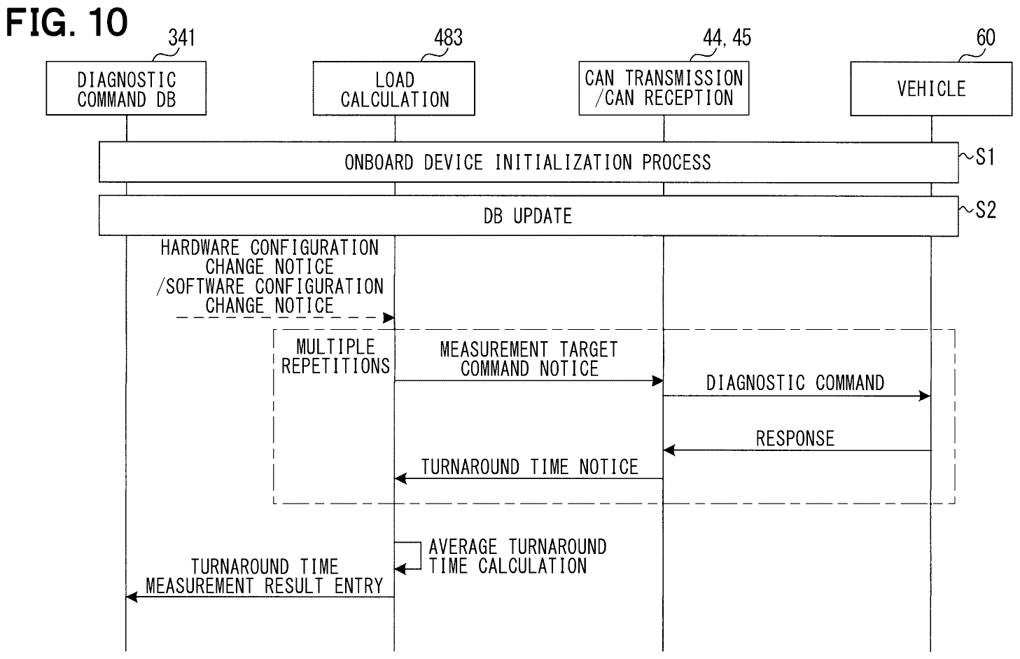

The operation of each part of the system when measuring the turnaround time of diagnostic commands used by the onboard device 30 will be explained using the sequence diagram shown in FIG. 10.

As shown in FIG. 10, after the onboard device initialization process S1 and the database update process S2 described earlier using FIG. 9 are completed, the load calculation unit 483 reads multiple pre-specified commands from the diagnostic command DB 341 for turnaround time measurement. One of the read commands is selected as the measurement target command, and the CAN transmission unit 44 is notified to measure the turnaround time using the selected measurement target command.

The CAN transmission unit 44 transmits the measurement target command to the CAN bus 62. At this time, the CAN reception unit 45 starts measuring the turnaround time. When the CAN reception unit 45 receives a response from the CAN bus 62, it stops measuring the turnaround time and transmits the measurement result to the load calculation unit 483.

The load calculation unit 483 performs similar processing for all the commands read from the diagnostic command DB 341 to obtain the turnaround time for each command. The load calculation unit 483 calculates the average value of the turnaround times after all the specified commands have been transmitted. Furthermore, the load calculation unit 483 stores the measurement results of the turnaround time for each command and the calculated average value in the diagnostic command DB 341 so that they can be used in the processing of the adjustment unit 482. Instead of the average value of the turnaround time, a value with a safety margin added to the average value may be used.

The load calculation unit 483 may measure the turnaround time each time the onboard device 30 is started. Additionally, as shown by the dotted lines in FIG. 10, the load calculation unit 483 may measure the turnaround time when it receives a notification of a hardware configuration change from the external device management unit 50. The load calculation unit 483 may measure the turnaround time when it receives a notification of a software configuration change from the vehicle-side application management unit 46.

### (3-3. Standard Vehicle Data Instruction Manual Update/Command Management Table Setting)

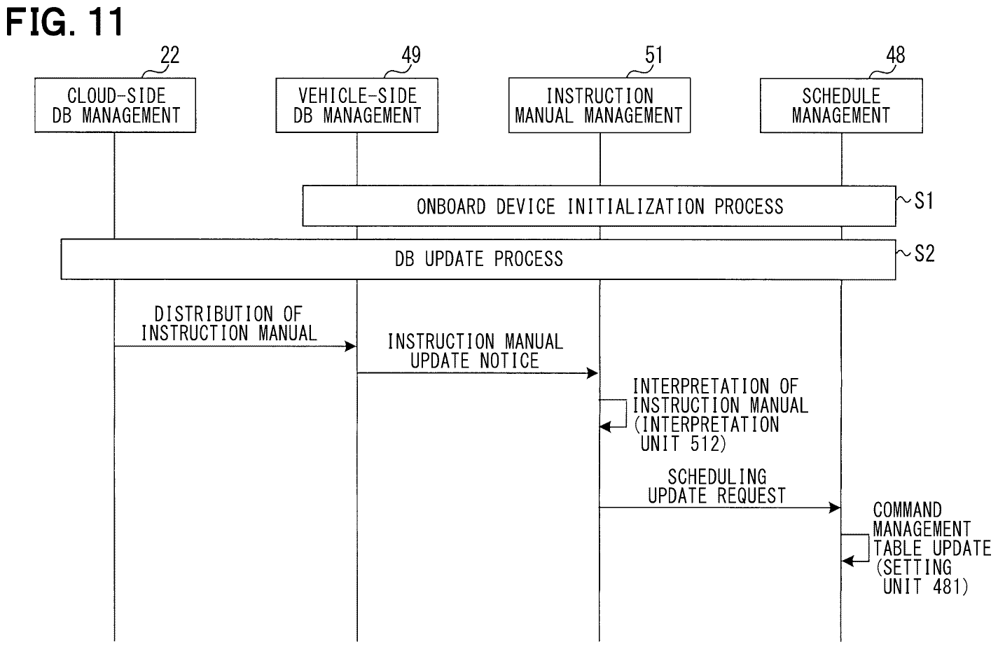

The operation of each part of the system when the standard vehicle data instruction manual is distributed from the cloud server 10 to the onboard device 30 will be explained using the sequence diagram shown in FIG. 11.

As shown in FIG. 11, the cloud-side DB management unit 22 of the cloud server 10 distributes the standard vehicle data instruction manual or update information of the standard vehicle data instruction manual (also referred to as a standard data instruction manual or the like) to each onboard device 30 at any timing. The cloud server 10 may distribute the standard data instruction manual or the like in response to a request from the onboard device 30 or together with the VIN-related information described earlier.

After the onboard device initialization process S1 and the database update process S2, the vehicle-side DB management unit 49 of the onboard device 30 receives the standard data instruction manual or the like from the cloud server 10, and transfers the received standard data instruction manual or the like to the instruction manual management unit 51.

The instruction manual management unit 51 stores the standard data instruction manual or the like transferred from the vehicle-side DB management unit 49 in the storage unit 511, and interprets the content of the standard data instruction manual or the like in the interpretation unit 512 to extract the information necessary for registration in the command management table. Specifically, the interpretation unit 512 extracts the command ID and the acquisition condition of the vehicle data (i.e., the “mode attribute” and the “mode sub-attribute”) and provides them to the schedule management unit 48.

The setting unit 481 of the schedule management unit 48 uses the information provided by the interpretation unit 512 of the instruction manual management unit 51 (also referred to as update information) to add or update the instruction-based management information included in the command management table shown in FIG. 8.

The update of the command management table based on the instruction manual is performed as follows. If there is no management information with the same command ID as indicated in the update information, new management information is added to the command management table. Even if the management information with the same command ID as the update information already exists in the command management table, new management information is added if the data acquisition condition or the like does not match. If the content of the update information completely matches the existing management information, the update information may be discarded, or the content of the existing management information may be updated with the update information.

The “transmission wait status” of the management information is set with the remaining tick count according to the acquisition condition of the vehicle data included in the update information when the management information is registered in the command management table.

The “transmission priority” of the instruction-based management information is set to an arbitrary initial value when the management information is registered in the command management table and is periodically updated according to the monitoring results of the API monitoring unit 484.

### (3-4. Application Distribution/Command Management Table Setting)

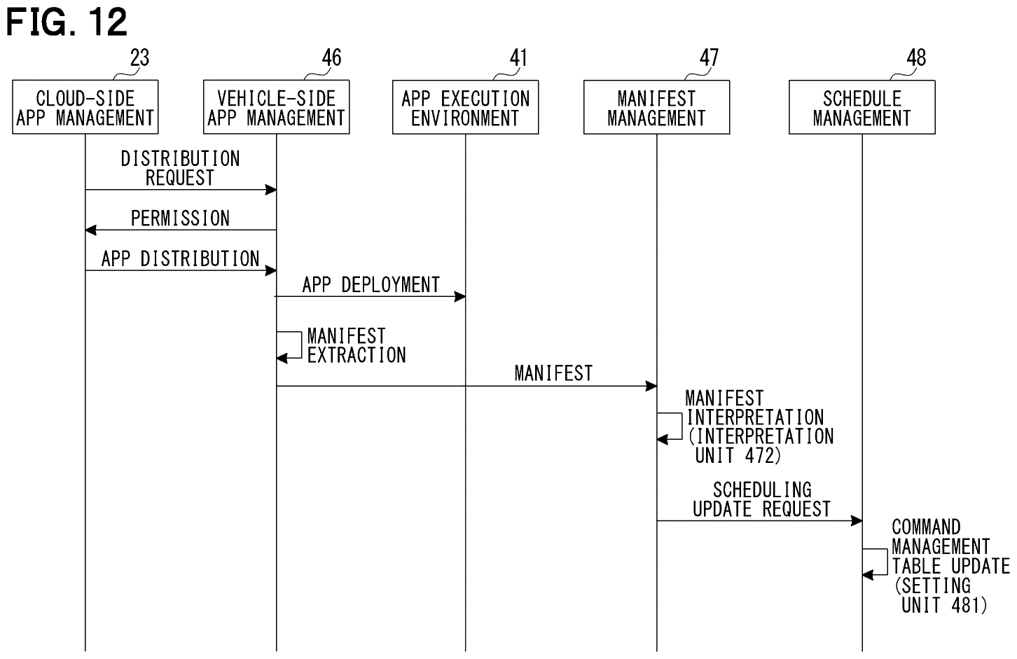

The operation of each part of the system when distributing diagnostic applications from the cloud server 10 to the onboard device 30 will be explained using the sequence diagram shown in FIG. 12.

As shown in FIG. 12, if a diagnostic application awaiting distribution is stored in the application DB 131, the cloud-side application management unit 21 of the cloud server 10 transmits a distribution request to the onboard device 30, requesting acceptance of the distribution of the diagnostic application.

When the vehicle-side application management unit 46 of the onboard device 30 receives the distribution request, it determines whether to accept the distribution according to the information indicated in the distribution request. If accepted, the vehicle-side application management unit 46 transmits an acceptance notification to the cloud server 10. The information used to determine whether to accept the distribution may include the memory capacity required to store the program, the CPU processing power, and the memory capacity required to execute the application.

The cloud-side application management unit 21 distributes the diagnostic application and the manifest stored in the application DB 131 to the onboard device 30 that has transmitted the acceptance notification. At this time, the cloud-side application management unit 21 may register information related to the onboard device 30 (e.g., VIN information of the vehicle equipped with the onboard device 30) in the application DB 131.

When the vehicle-side application management unit 46 receives the diagnostic application from the cloud server 10, it deploys the received diagnostic application 411 so that it can be executed in the application execution environment 41. Additionally, the vehicle-side application management unit 46 provides the manifest attached to the diagnostic application 411 to the manifest management unit 47. The deployed diagnostic application 411 is assigned an application ID, which is also associated with the manifest provided to the manifest management unit 47.

The manifest management unit 47 stores the manifest provided by the vehicle-side application management unit 46 in the storage unit 471 and interprets the content of the manifest in the interpretation unit 472 to extract the information necessary for registration in the command management table. Specifically, the interpretation unit 472 extracts the application ID associated with the manifest, the command ID, the vehicle data acquisition condition (i.e., the “mode attribute” and the “mode sub-attribute”), and the transmission priority, and provides them to the schedule management unit 48.

If the “mode attribute” of the manifest is the periodic drive and the period value indicated in the “mode sub-attribute” is shorter than the tick, the vehicle-side application management unit 46 may be notified that vehicle data cannot be obtained at the requested timing. Upon receiving the notification, the vehicle-side application management unit 46 may delete the corresponding diagnostic application and notify the cloud server 10 of the deletion along with the reason.

The setting unit 481 of the schedule management unit 48 uses the information provided by the interpretation unit 472 of the manifest management unit 47 (also referred to as update information) to add or update the management information based on the manifest included in the command management table shown in FIG. 7.

The update of the command management table based on the manifest is performed similarly to the update of the command management table based on the instruction manual.

The “transmission priority” of the management information based on the manifest may use the priority value included in the update information, the priority value set according to the vehicle data acquisition condition, or the priority value set according to the data type of the vehicle data.

### (3-5. Transmission Wait Status Update)

The operation of the adjustment unit 482 of the schedule management unit 48 to update the “transmission wait status” in the command management table will be explained.

The adjustment unit 482 decrements the remaining tick count indicated in the “transmission wait status” and the “supplementary information (i.e., remaining transmission count)” for the management information registered in the command management table for the periodic drive each time the schedule adjustment process described later is completed. However, for the management information with a remaining tick count of 0 in the “transmission wait status” before decrementing, the remaining tick count is preset to the value corresponding to the period value instead of decrementing.

If the remaining tick count in the “supplementary information” becomes 0 as a result of decrementing, the adjustment unit 482 deletes the corresponding management information from the command management table.

When the adjustment unit 482 receives a trigger signal from the external device management unit 50 or the CAN reception unit 45, the adjustment unit 482 sets the “transmission wait status” of the management information corresponding to the received trigger signal to 0 in the command management table for the event drive.

When the adjustment unit 482 receives an immediate acquisition request for vehicle data from the diagnostic application via the API group 42, the adjustment unit 482 sets the “transmission wait status” of the management information corresponding to the received immediate acquisition request to 0 in the command management table for the immediate drive.

### (3-6. Schedule Adjustment)

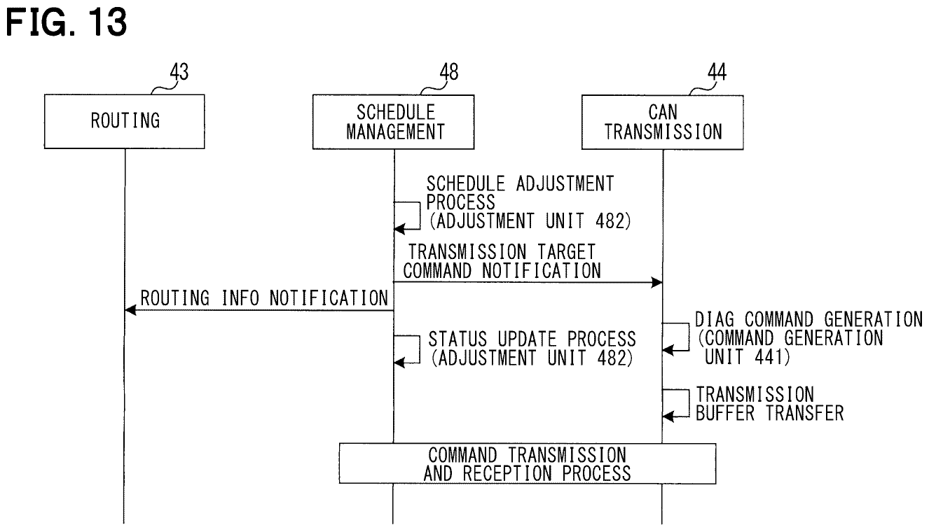

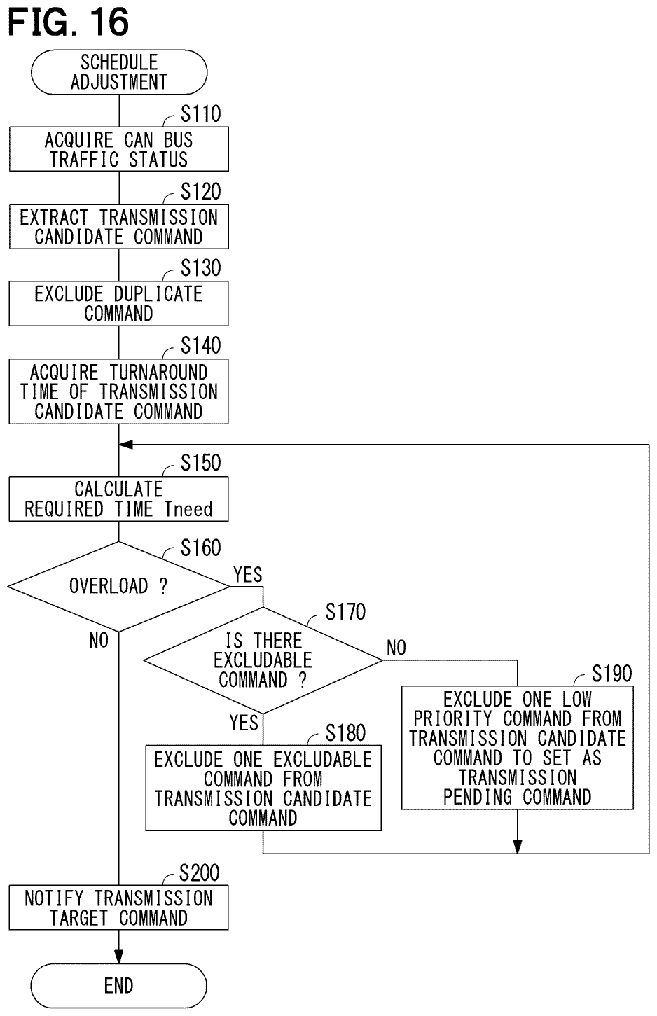

The schedule adjustment process by which the adjustment unit 482 of the schedule management unit 48 determines the diagnostic commands to be transmitted in the next tick using the command management table will be explained using the sequence diagram in FIG. 13 and the flowchart in FIG. 16.

The adjustment unit 482 executes the schedule adjustment process for each tick.

When the schedule adjustment process starts, the adjustment unit 482 first obtains the traffic status of the CAN bus 62 in step S110. The traffic status may be obtained using information from an ECU 63 that measures the traffic of the CAN bus 62 or by separately measuring it in the onboard device 30. Additionally, the traffic status may use static information (also referred to as static traffic information) pre-registered in the system. Static traffic information may be, for example, an average value measured for each vehicle model or a value with a safety margin added to the average value. Static traffic information may also be included in the information stored in the diagnostic command DB 341. Furthermore, static traffic information may be used when dynamic traffic information, which represents the dynamically measured traffic status at that time, cannot be obtained from the ECU 63 or the onboard device 30.

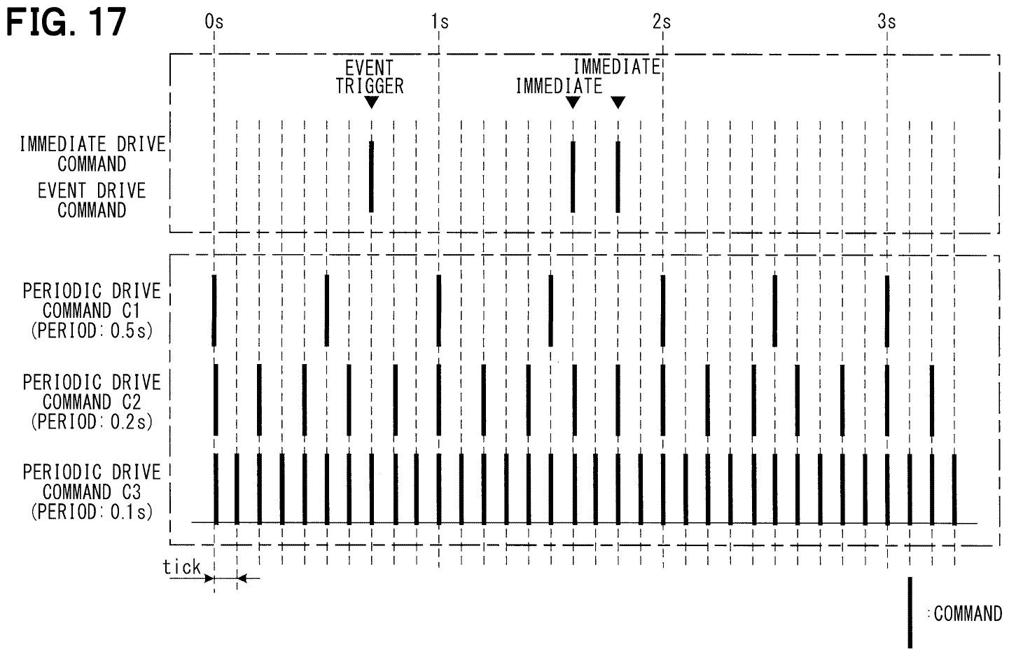

In the subsequent step S120, the adjustment unit 482 refers to the “transmission wait status” in the command management table and extracts all management information with a remaining tick count set to 0, that is, all management information to be processed in the next tick, as transmission candidate commands. The transmission candidate commands (i.e., diagnostic command transmission requests) extracted for each tick based on the command management table are illustrated in FIG. 17. FIG. 17 shows a case where there are three periodic drive commands C1 to C3, one event drive command, and two immediate drive commands. The periodic drive command C1 is processed at a period of 0.5 seconds (i.e., 5 ticks), the periodic drive command C2 is processed at a period of 0.2 seconds (i.e., 2 ticks), and the periodic drive command C3 is processed at a period of 0.1 seconds (i.e., 1 tick). FIG. 17 shows the transmission schedule of diagnostic commands before load adjustment.

In the subsequent step S130, if there is duplicate management information with the same command ID among the management information extracted as transmission candidate commands, the adjustment unit 482 excludes the duplicate management information from the transmission candidate commands, leaving only one management information. However, if there is duplicate management information based on the manifest and the instruction manual, the management information based on the manifest is retained, and the management information based on the instruction manual is excluded from the transmission candidate commands. Additionally, the adjustment unit 482 generates routing information to be provided to the routing unit 43. The routing information is information that associates the command ID indicated by the transmission candidate commands with the application ID of the requesting application based on the information shown in the command management table. In the routing information, each command ID is associated with one or more application IDs. In other words, if the transmission candidate command is management information based on the manifest, routing information is generated, and if the transmission candidate command is management information based on the instruction manual, routing information is not generated.

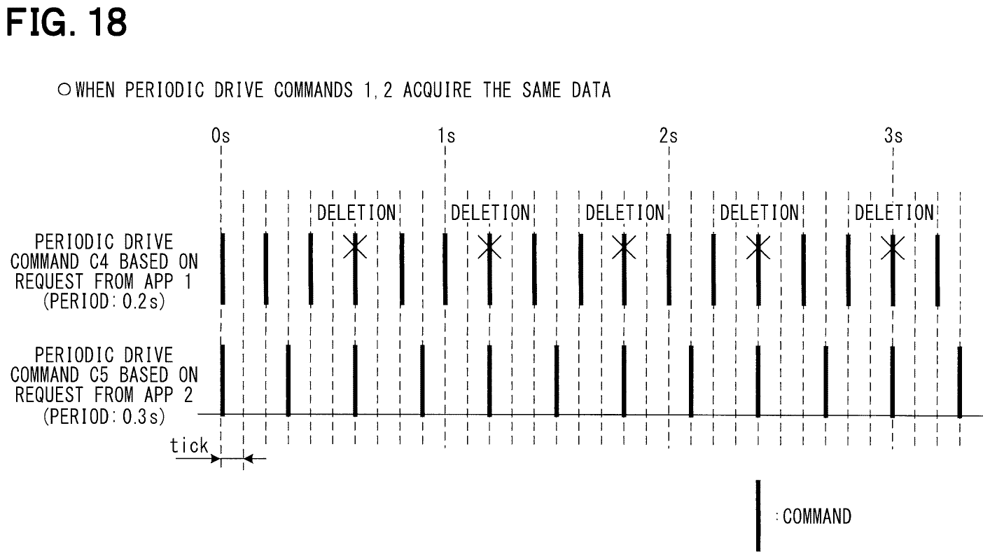

For example, as shown in FIG. 18, if periodic drive commands C4 and C5 are set to obtain the same vehicle data at different periods from multiple diagnostic applications 411, the requests from both applications may overlap in the same tick. In such cases, instead of transmitting both overlapping periodic drive commands C4 and C5, the adjustment is made to transmit only one (e.g., the command C5 in FIG. 18). Since the CAN information alone, which does not manage sessions, makes it unclear which application the obtained vehicle data corresponds to, routing information is used to ensure that the obtained vehicle data is correctly provided to the requesting application.

In the subsequent step S140, the adjustment unit 482 obtains the turnaround time for all transmission candidate commands. The turnaround time for each command may use the measured values stored in the diagnostic command DB 341, as explained earlier, or the average value of the turnaround times calculated from the measured values, or the design values.

In the subsequent step S150, the adjustment unit 482 calculates the required time Tneed necessary to transmit all transmission candidate commands using alternate communication. The required time Tneed is the total of the turnaround times for all transmission candidate commands. The turnaround time may be corrected to be longer according to the traffic status obtained in step S110, the more congested it is.

In the subsequent step S160, the adjustment unit 482 determines whether the processing in the next tick will result in overload. Overload occurs when the required time Tneed calculated in step S150 is greater than the tick or when transmitting the transmission candidate commands will cause the estimated traffic on the CAN bus 62 to exceed the allowable value. If the adjustment unit 482 determines in step S160 that there is no overload, the process proceeds to step S200. If it determines that there is overload, the process proceeds to step S170.

In step S170, the adjustment unit 482 determines whether there are any excludable commands among the transmission candidate commands. For example, transmission candidate commands with a priority value below the exclusion threshold may be considered excludable commands.

If there are excludable commands among the transmission candidate commands, the adjustment unit 482 proceeds to step S180. If there are no excludable commands, the process moves to step S190.

In step S180, the adjustment unit 482 excludes at least one of the excludable commands from the transmission candidate commands and also excludes the information related to the excluded transmission candidate commands from the routing information, then returns to step S150. The adjustment unit 482 may also notify the requesting application of the excluded transmission candidate commands that the request was not processed.

In step S190, the adjustment unit 482 excludes at least one command with the lowest priority value or a command with a period value of a predetermined value (e.g., 10 ticks) or more from the transmission candidate commands, designating it as a transmission pending command. The adjustment unit 482 also excludes the information related to the transmission pending command from the routing information. Furthermore, the adjustment unit 482 increases the remaining tick count of the “transmission wait status” of the transmission pending command in the command management table by 1 so that the transmission pending command is extracted again as a transmission candidate command in the next tick, then returns to step S150. The number by which the remaining tick count is increased is not limited to 1, and may be a number randomly selected within a certain range. The certain range may be set to be larger during congestion according to the traffic status of the CAN bus 62.

In step S200, the adjustment unit 482 notifies the CAN transmission unit 44 of the transmission candidate commands as transmission target commands and notifies the routing unit 43 of the routing information, then ends the process.

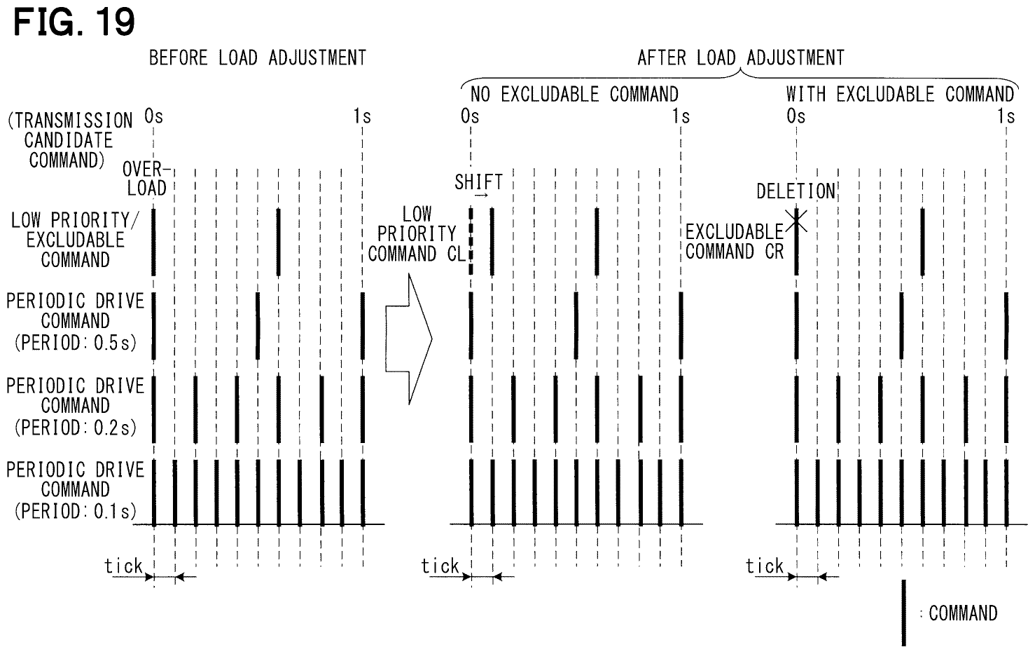

In other words, as shown in FIG. 19, if an overload occurs, the load on the CAN bus 62 is adjusted by excluding the excludable command CR if the excludable command CR is included among the transmission candidate commands. If no excludable command CR is included, the load on the CAN bus 62 is adjusted by ensuring that the transmission candidate command with the lowest priority CL or a command with a period value of a predetermined value or more is transmitted in subsequent ticks.

As shown in FIG. 13, when the CAN transmission unit 44 receives the notification of the transmission target commands, the CAN transmission unit 44 retrieves the bit pattern representing the diagnostic command from the diagnostic command DB 341 according to the command ID indicated in the management information of the transmission target commands. The CAN transmission unit 44 generates a transmission frame (i.e., CAN frame) with the retrieved bit pattern set in the payload and transfers to the transmission buffer.

The CAN frame transferred to the transmission buffer is transmitted and received according to the diagnostic communication process on the CAN bus 62.

### (3-7. Response Reception)

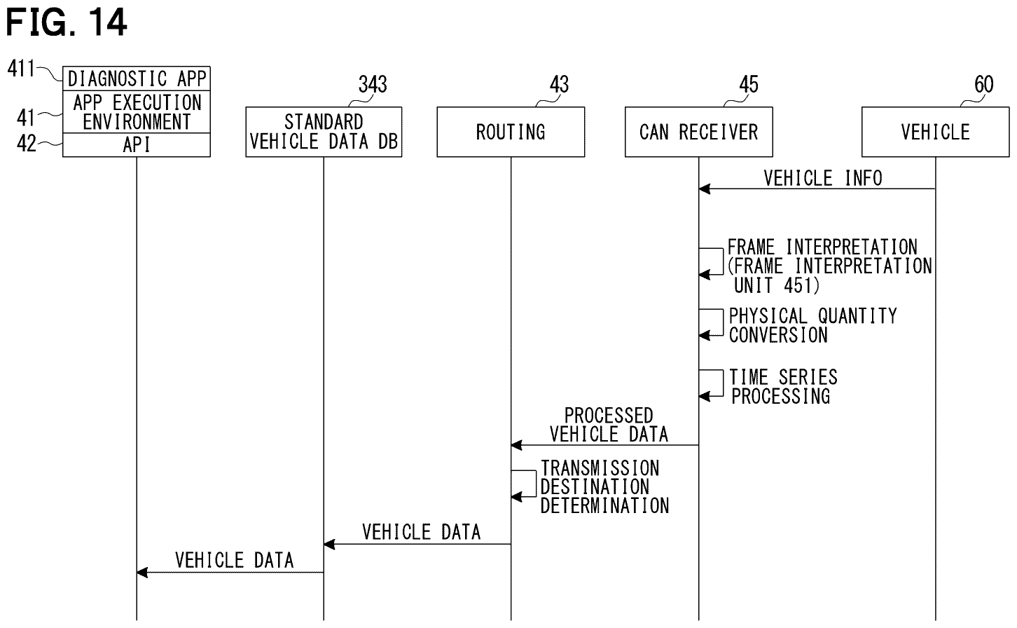

The operation when the onboard device 30 transmits a CAN frame containing a diagnostic command and receives a CAN frame containing a response (i.e., vehicle data) from the vehicle 60 will be explained using the sequence diagram shown in FIG. 14.

As shown in FIG. 14, when the CAN reception unit 45 receives a CAN frame indicating a response to the diagnostic command, the frame interpretation unit 451 performs bit analysis on the payload of the received CAN frame. The bit analysis uses the frame interpretation information stored in the frame interpretation DB 342. The vehicle data obtained through bit analysis may represent some state (e.g., switch on/off) or a sampled value of an analog signal (i.e., a physical quantity). If the vehicle data represents a physical quantity, the frame interpretation unit 451 may convert the obtained physical quantity into a predetermined unit (e.g., a unit used by the requesting application) or perform time-series processing on the obtained physical quantity. Time-series processing includes operations such as differentiation, integration, and smoothing on the obtained vehicle data. The vehicle data obtained through bit analysis is specific vehicle data and may be converted into standard vehicle data according to the normalization rules stored in the frame interpretation DB 342.

The CAN reception unit 45 notifies the routing unit 43 of the vehicle data processed by the frame interpretation unit 451 along with the command ID representing the diagnostic command transmitted to obtain the vehicle data.

If the vehicle data processed by the frame interpretation unit 451 is standard vehicle data, the CAN reception unit 45 adds the separately obtained peripheral information “time,” “latitude,” and “longitude” to the information “system,” “control label,” and “vehicle data” extracted from the CAN ID and CAN data of the received frame and stores it in the standard vehicle data DB 343. The standard vehicle data DB 343 may store not only standard vehicle data obtained based on the instruction manual but also standard vehicle data obtained based on the manifest.

The routing unit 43 identifies the application ID corresponding to the command ID by referring to the routing information notified by the schedule management unit 48 based on the command ID and vehicle data notified by the CAN reception unit 45. Furthermore, the routing unit 43 notifies the vehicle data to the requesting application indicated by the application ID via the application execution environment 41.

In other words, all vehicle data obtained based on the instruction manual is standard vehicle data and is stored in the standard vehicle data DB 343. Additionally, vehicle data obtained based on the manifest is provided to the requesting application via the routing unit 43. If the vehicle data is standard vehicle data, the vehicle data is not only provided to the requesting application but also stored in the standard vehicle data DB 343.

### (3-8. Standard Vehicle Data Acquisition)

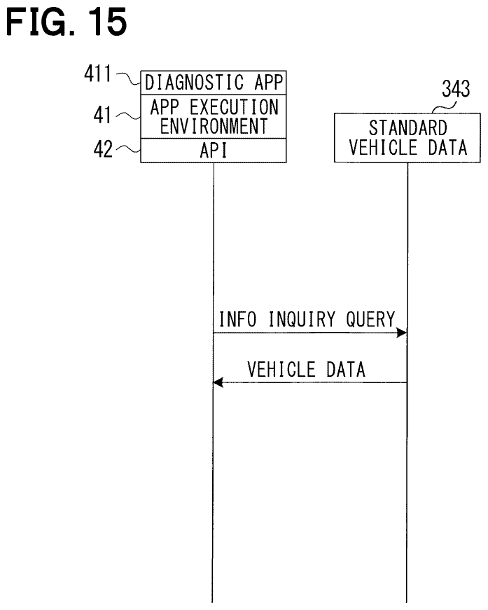

The operation of the system when the diagnostic application 411 obtains standard vehicle data using the standard data API belonging to the API group 42 will be explained using the sequence diagram shown in FIG. 15.

As shown in FIG. 15, the diagnostic application 411 can obtain various standard vehicle data by accessing the standard vehicle data DB 343 using the standard data API. Standard vehicle data can be obtained not only as the latest data but also as past data by specifying the acquisition time and acquisition location.

In this embodiment, the CAN transmission unit 44 and the CAN reception unit 45 correspond to the data acquisition unit in this disclosure. The standard vehicle data DB 343 corresponds to the standard vehicle data storage unit in this disclosure. The application execution environment 41 corresponds to the application execution unit in this disclosure. The vehicle-side DB management unit 49 corresponds to the peripheral information acquisition unit and the standard vehicle data transmission unit in this disclosure, and the diagnostic command information, frame interpretation information, and normalization rules correspond to the peripheral information in this disclosure.

According to the embodiment described in detail above, the following effects are achieved as an example.

In the data provision system 1, the onboard device 30 generates management information to be registered in the command management table according to the standard vehicle data instruction manual. The onboard device 30 then uses the management information registered in the command management table to obtain standard vehicle data via the diagnostic port 61 of the vehicle 60 and stores it in the standard vehicle data DB 343. Multiple diagnostic applications 411 arranged in the onboard device 30 are configured to obtain any standard vehicle data from the standard vehicle data DB 343 using the standard data API belonging to the API group 42.

Therefore, according to the onboard device 30, it is possible to operate multiple diagnostic applications 411 that utilize the standard vehicle data obtained through diagnostic communication simultaneously. In other words, the diagnostic port 61 of the vehicle 60 can be used simultaneously for multiple different purposes.

In the data provision system 1, the onboard device 30 is configured to upload the standard vehicle data stored in the standard vehicle data DB 343 to the digital twin DB 133 of the cloud server 10.

Therefore, in the data provision system 1, it is possible to easily construct the system using the configuration provided in the onboard device 30 to build the digital twin DB 133.

In the data provision system 1, the onboard device 30 generates management information to be registered in the command management table according to the manifest distributed along with the diagnostic applications 411 from the cloud server 10. The onboard device 30 then uses the management information registered in the command management table to adjust the timing for processing the acquisition requests for multiple vehicle data specified in the manifest.

Therefore, according to the onboard device 30, it is possible to provide any vehicle data indicated in the manifest to the diagnostic applications 411, not limited to the standard vehicle data indicated in the standard vehicle data instruction manual.

The onboard device 30 manages the acquisition schedule of vehicle data according to the standard vehicle data instruction manual and the manifest. Additionally, the onboard device 30 generates diagnostic commands suitable for the installed vehicle 60 and interprets the responses from the installed vehicle 60 according to the VIN-related information. Therefore, application developers can develop diagnostic applications 411 even if they lack knowledge about the diagnostic communication of the vehicle 60 to which the application is distributed.

The onboard device 30 creates routing information to associate the transmitted diagnostic commands with the requesting applications. Therefore, even if duplicate command transmission requests occur at the same tick timing and the duplicate commands are deleted, the obtained vehicle data can be correctly provided to all requesting applications by referring to the routing information.

The onboard device 30 performs load adjustment if there is a possibility of overload when transmitting all transmission candidate commands extracted from the command management table. In load adjustment, some of the transmission candidate commands are excluded from the transmission target or adjusted to be processed in subsequent ticks. Therefore, the traffic on the CAN bus 62 can be kept within the allowable range, and delays or other impacts on the transmission and reception of regular commands (e.g., vehicle control commands) between ECUs 63 can be suppressed. Additionally, application developers can develop diagnostic applications 411 that operate safely without knowledge of traffic restrictions on the CAN bus 62 in each vehicle 60.

In the onboard device 30, for periodic drive requests, the priority is set lower as the period value increases. In other words, the impact of the delay caused by the postponement of low-priority command transmission due to overload is relatively smaller as the period value of the postponed command increases, thereby minimizing the impact on the functions realized by the requesting applications.

### OTHER EMBODIMENTS

While the embodiments of this disclosure have been described above, this disclosure is not limited to the above embodiments and can be implemented in various modifications.

In the above embodiment, when there is an overload, if there are no excludable commands, the processing of low-priority commands or commands with long data acquisition periods is delayed. The processing of commands related to the immediate drive or the event drive may also be delayed.

In the above embodiment, diagnostic communication on the CAN bus 62 is based on alternate transmission, where each command is completed one by one by waiting for a response from the vehicle, as shown in FIG. 20A. This disclosure is not limited to alternate transmission. A parallel transmission, where commands are transmitted without waiting for a response from the vehicle, as shown in FIG. 20B, may also be performed. In this case, it is necessary to adjust the number of commands that can be transmitted in parallel to ensure that the traffic does not exceed the allowable range.

In the above embodiment, standard vehicle data stored in the standard vehicle data DB 343 is obtained by transmitting diagnostic commands. The method of acquiring standard vehicle data is not limited to transmitting diagnostic commands. For example, if the vehicle 60 is configured to receive all frames flowing on the CAN bus 62 via the diagnostic port 61, the CAN reception unit 45 may obtain standard vehicle data flowing on the CAN bus 62 independently of the transmission of diagnostic commands. In this case, the CAN reception unit 45 corresponds to the passive data acquisition unit in this disclosure.

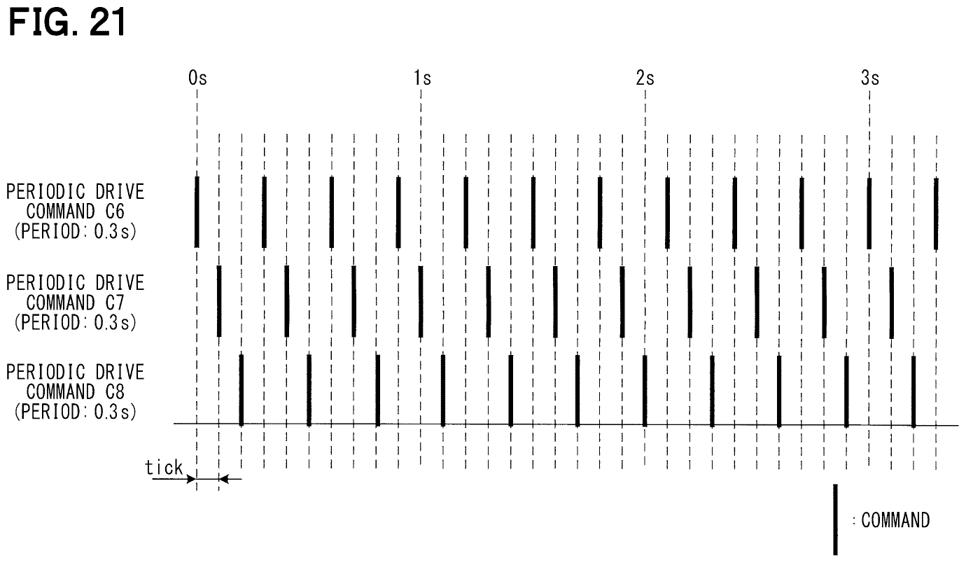

In the above embodiment, when adding management information to the command management table according to the manifest, the initial value of the “transmission wait status” is set to a value corresponding to the period value. The initial value of the “transmission wait status” may be adjusted to prevent the transmission candidate commands from concentrating on the same tick. For example, as shown in FIG. 21, if there are three periodic drive commands C6 to C8 with an acquisition period of 3 ticks, the initial value of the “transmission wait status” at the time of registering the management information may be adjusted so that each periodic drive command C6 to C8 is processed in different ticks.

In the above embodiment, the transmission priority of duplicated but not deleted commands is not specifically described. The transmission priority of such commands may be temporarily set higher for processing in that tick. In other words, even if the transmission priority is low, commands with multiple request sources may be adjusted to ensure transmission as much as possible.

In the above embodiment, the transmission priority between management information based on the manifest and management information based on the instruction manual is not specified. Management information based on the manifest may be given higher priority, or conversely, management information based on the instruction manual may be given higher priority.

In the above embodiment, in step S120 of the schedule adjustment process, the adjustment unit 482 refers to the “transmission status” in the command management table and extracts all management information with a remaining tick count set to 0, that is, all management information to be processed in the next tick, as transmission candidate commands. However, the method of extracting transmission candidate commands is not limited to this. For example, in step S120, the adjustment unit 482 may refer to the “transmission status” in the command management table and extract all management information with a remaining tick count set to 1, that is, all management information to be processed in the next tick but one, as transmission candidate commands. In this case, in steps S130 to S190, the transmission candidate commands to be processed in the next tick but one, extracted in step S120 of the current schedule adjustment process, are narrowed down. In step S200, the transmission candidate commands with a remaining tick count set to 0, that is, the transmission candidate commands extracted and narrowed down in the previous schedule adjustment process, may be processed as transmission target commands.

When adopting this schedule adjustment process, the “transmission wait status” with the “mode attribute” of the immediate drive may be set to a predetermined number of 1 or more when a request from the diagnostic application 411 occurs. Similarly, the “transmission wait status” with the “mode attribute” of the event drive may be set to a predetermined number of 1 or more when the specified trigger condition is satisfied.

In step S120 of the schedule adjustment process, the adjustment unit 482 may refer to the “transmission wait status” in the command management table and extract all management information set to a predetermined tick count greater than 1 as transmission candidate commands. In step S200, the adjustment unit 482 may refer to the “transmission wait status” in the command management table and process the transmission candidate commands with a remaining tick count set to 0 as transmission target commands. In this case, the “transmission wait status” with the “mode attribute” of the immediate drive may be set to a predetermined number of ticks or more when a request from the diagnostic application 411 occurs. Similarly, the “transmission wait status” with the “mode attribute” of the event drive may be set to a predetermined number of ticks or more when the specified trigger condition is satisfied.

In the above embodiment, steps S120 to S190 of the schedule adjustment process are executed for each transmission period, that is, for each tick. However, they may be executed for multiple transmission periods, for example, every 2 ticks. In this case, in step S120, the adjustment unit 482 may refer to the “transmission wait status” in the command management table and extract all management information set to 0 or 1 remaining ticks as transmission candidate commands. In this case, in steps S130 to S190, the transmission candidate commands extracted in step S120 are narrowed down. In step S200, all transmission candidate commands that remain without being excluded by the narrowing down may be processed as transmission target commands.

In the above embodiment, the immediate drive is used in a mode where specified vehicle data is obtained “immediately” once according to the instructions from the diagnostic application. As described in the variation of the schedule adjustment process, the “transmission wait status” with the “mode attribute” of the immediate drive may be set to a predetermined number of ticks or more instead of being set to 0 when a request from the diagnostic application 411 occurs. In other words, instead of acquiring vehicle data “immediately,” it may be obtained within a limited time. In this case, the “mode attribute” can be understood as an application drive, which is a higher concept of the immediate drive. The application drive is a mode in which vehicle data is obtained according to the request from the application program.

In the above embodiment, when the “mode attribute” is the immediate drive or the event drive, the tick count set as the “transmission wait status” indicates the timing for executing the process, but it may also represent the latest permissible timing for executing the process. In this case, in the schedule adjustment process, if there is room in the processing load, transmission candidate commands with a remaining tick count other than 0 may be added to the transmission target commands and processed.

The control unit 31 and its methods described in this disclosure may be implemented by a dedicated computer provided by configuring a processor and memory programmed to execute one or more functions embodied by a computer program. Alternatively, the control unit 31 and its methods described in this disclosure may be implemented by a dedicated computer provided by configuring a processor with one or more dedicated hardware logic circuits. Alternatively, the control unit 31 and its methods described in this disclosure may be implemented by one or more dedicated computers provided by a combination of a processor and memory programmed to execute one or more functions and one or more hardware logic circuits. Additionally, the computer program may be stored as instructions executable by a computer on a computer-readable non-transitory tangible recording medium. The methods for realizing the functions of each part included in the control unit 31 do not necessarily need to include software, and all functions may be realized using one or more hardware components.

The multiple functions possessed by one component in the above embodiment may be realized by multiple components, or one function possessed by one component may be realized by multiple components. Additionally, multiple functions possessed by multiple components may be realized by one component, or one function realized by multiple components may be realized by one component. Furthermore, part of the configuration of the above embodiment may be omitted. Additionally, at least part of the configuration of the above embodiment may be added to or replaced with the configuration of another embodiment described above.

Besides the onboard device 30 described above, this disclosure can also be realized in various forms such as a data provision system including the onboard device 30, a program for making a computer function as the onboard device 30, a non-transitory tangible recording medium such as a semiconductor memory recording this program, and a data provision method.

In the embodiments of the present disclosure, unless a technical contradiction arises, the number of components, data, functions, modules, and steps is not particularly limited, and may be singular or plural. In other words, the specific configurations, data, functions, modules and steps of each embodiment can be appropriately modified as needed, and such modifications do not limit the technical scope of the present disclosure.

What is claimed is:

1. An onboard device comprising:
a data acquisition unit configured to execute a transmission process to transmit a command to a vehicle network of a vehicle equipped with the onboard device according to an instruction manual indicating one or more types of standard vehicle data, which are standardized vehicle data, and obtain specific vehicle data, which is vehicle data indicated in a format unique to a vehicle, from the vehicle network;
a standard vehicle data storage unit configured to convert the specific vehicle data obtained by the data acquisition unit into a format of the standard vehicle data and store the standard vehicle data;
an application execution unit configured to execute one or more application programs that utilize the standard vehicle data; and
an application programming interface (API) group, which is a collection of application programming interfaces prepared for each of the standard vehicle data, configured to provide a function to obtain the standard vehicle data from the standard vehicle data storage unit for the one or more application programs executed by the application execution unit.

2. The onboard device according to claim 1, wherein:
the onboard device is connected to the vehicle network via a diagnostic port provided in the vehicle; and
the data acquisition unit is configured to use as the command, a diagnostic command used in diagnostic communication.

3. The onboard device according to claim 1, further comprising:
a schedule management unit configured to extract, as a transmission target command to be the command to be transmitted in the transmission process, the command indicated by management information that meets a acquisition condition, using one or more management information indicating a type of a command used to obtain the specific vehicle data corresponding to the standard vehicle data and the acquisition condition of the standard vehicle data.

4. The onboard device according to claim 3, wherein:
the data acquisition unit is configured to repeatedly execute the transmission process at a preset execution cycle; and
the schedule management unit is configured to extract the command indicated by the management information that meets the acquisition condition as the transmission target command in a next and subsequent execution cycles.

5. The onboard device according to claim 3, wherein:
a manner for specifying the acquisition condition includes a periodic drive, which obtains data repeatedly at a fixed cycle, and an event drive, which obtains data when a specified event occurs.

6. The onboard device according to claim 3, wherein:
the schedule management unit is configured to exclude a part of the transmission target command from processing of a transmission when transmitting all transmission target commands extracted from the one or more management information in the transmission process could cause an overload on the vehicle network, thereby preventing the overload.

7. The onboard device according to claim 6, wherein:
the schedule management unit is configured to determine that the overload occurs when a traffic of the vehicle network exceeds an allowable value.

8. The onboard device according to claim 4, wherein:
the schedule management unit is configured to exclude a part of the transmission target command from processing of a transmission when transmitting all transmission target commands extracted from the one or more management information in the transmission process could cause an overload on the vehicle network, thereby preventing the overload; and
the schedule management unit is configured to determine that the overload occurs when a total value of a turnaround time of the transmission target command exceeds the execution cycle of the transmission process.

9. The onboard device according to claim 8, wherein:
the data acquisition unit is configured to measure the turnaround time at a start of the onboard device.

10. The onboard device according to claim 8, wherein:
the data acquisition unit is configured to measure the turnaround time when there is a change in a configuration of hardware connected to the onboard device or a configuration of software executed by the application execution unit.

11. The onboard device according to claim 4, wherein:
the schedule management unit is configured to exclude a part of the transmission target command from processing of a transmission when transmitting all transmission target commands extracted from the one or more management information in the transmission process could cause an overload on the vehicle network, thereby preventing the overload;
the management information includes a priority concerning the transmission of the command; and
the schedule management unit is configured to exclude at least one of the management information with lowest priority, the management information with a priority below an exclusion threshold, and the management information with an acquisition cycle that is 10 times or more than the execution cycle, from the transmission target command when it is determined that the overload occurs.

12. The onboard device according to claim 11, wherein:
the schedule management unit is configured to adjust the management information so that the management information excluded from the transmission target command is extracted as the transmission target command in an execution cycle after an execution cycle in which the transmission target command is excluded.

13. The onboard device according to claim 11, further comprising:
an API monitoring unit configured to monitor usage status of each of the application programming interfaces belonging to the API group,
wherein
the priority is set to a higher value as usage frequency of the application programming interface used to obtain the vehicle data corresponding to the priority is higher, based on a monitoring result of the API monitoring unit.

14. The onboard device according to claim 11, wherein:
the priority is set according to a data type of the vehicle data corresponding to the priority.

15. The onboard device according to claim 11, wherein:
the priority is set according to the acquisition condition of the vehicle data corresponding to the priority.

16. The onboard device according to claim 1, further comprising:
a peripheral information acquisition unit configured to obtain peripheral information, including the instruction manual, information for interpreting a frame received from the vehicle network, information for converting the specific vehicle data obtained by interpreting the frame into the standard vehicle data, and a list of commands usable in the vehicle, through wireless communication with a server provided outside the vehicle.

17. The onboard device according to claim 1, wherein:
the vehicle data obtained by the data acquisition unit includes at least one of vehicle speed, total mileage, vehicle body acceleration, vehicle body angular velocity, global positioning system location information, gear position, battery charge status, fuel tank capacity, remaining fuel amount, average fuel consumption amount, light on/off status, interior/exterior temperature, air conditioner operation status, door/window open/close status, door/window lock status, seat belt status, airbag status, tire pressure, parking brake status, accelerator pedal position, brake pedal position, brake pressure, and diagnostic trouble code list.

18. The onboard device according to claim 3, wherein:
the schedule management unit is configured to obtain a manifest, which is associated with the application program and describes a type of vehicle data required by the application program and the acquisition condition of the vehicle data, from a distribution source of the application program, and generate the management information according to the manifest;
the management information includes information to identify a requesting application, which is the application program that requests the vehicle data, in addition to the type of vehicle data and the acquisition condition of the vehicle data;
the schedule management unit is configured to generate routing information that associates the transmitted command and the vehicle data obtained by the command with the requesting application; and
the onboard device further comprises a routing unit configured to provide the vehicle data obtained by the data acquisition unit executing the transmission process to the requesting application using the routing information.

19. The onboard device according to claim 1, further comprising:
a passive data acquisition unit configured to extract the specific vehicle data from a frame flowing through the vehicle network independently of a transmission of the command, convert the extracted specific vehicle data into the standard vehicle data, and store the standard vehicle data in the standard vehicle data storage unit.

20. The onboard device according to claim 1, further comprising:
a standard vehicle data transmission unit configured to wirelessly transmit the standard vehicle data stored in the standard vehicle data storage unit to a server provided outside the vehicle.

21. A data provision system comprising:
one or more onboard devices; and
a server provided outside a vehicle equipped with the onboard device,
wherein:
the onboard device includes
a data acquisition unit configured to execute a transmission process to transmit a command to a vehicle network of a vehicle equipped with the onboard device according to an instruction manual indicating one or more types of standard vehicle data, which are standardized vehicle data, and obtain specific vehicle data, which is vehicle data indicated in a format unique to a vehicle, from the vehicle network,
a standard vehicle data storage unit configured to convert the specific vehicle data obtained by the data acquisition unit into a format of the standard vehicle data and store the standard vehicle data,
an application execution unit configured to execute one or more application programs that utilize the standard vehicle data, and
an application programming interface (API) group, which is a collection of application programming interfaces prepared for each of the standard vehicle data, configured to provide a function to obtain the standard vehicle data from the standard vehicle data storage unit for the one or more application programs executed by the application execution unit; and
the server includes a digital twin database that stores at least one of the standard vehicle data transmitted from each of the onboard devices and the digital twin data emulating the vehicle equipped with the onboard device generated based on the standard vehicle data.

22. A method for providing an application execution environment to provide one or more application programs arranged in an onboard device with vehicle data obtained via a vehicle network of a vehicle equipped with the onboard device, the method comprising:
executing a transmission process to obtain specific vehicle data, which is vehicle data indicated in a format unique to the vehicle, from the vehicle network by transmitting a command to the vehicle network according to an instruction manual indicating one or more types of standard vehicle data, which are standardized vehicle data;
converting the specific vehicle data obtained by executing the transmission process into a format of the standard vehicle data and storing the standard vehicle data in a standard vehicle data storage unit; and
providing the standard vehicle data to the application program by an API group, which is a collection of application programming interfaces prepared for each of the standard vehicle data, to provide a function to obtain the standard vehicle data from the standard vehicle data storage unit.

23. A non-transitory computer readable storage medium storing a program for providing vehicle data obtained via a vehicle network of a vehicle equipped with an onboard device to one or more application programs arranged in the onboard device, the program comprising instructions configured to, when executed by a processor, cause the processor to:
execute a transmission process to obtain specific vehicle data, which is vehicle data indicated in a format unique to the vehicle, from the vehicle network by transmitting a command to the vehicle network according to an instruction manual indicating one or more types of standard vehicle data, which are standardized vehicle data;
convert the specific vehicle data obtained by executing the transmission process into the format of the standard vehicle data and store the standard vehicle data in a standard vehicle data storage unit; and
provide the standard vehicle data to the application program by an API group, which is a collection of application programming interfaces prepared for each of the standard vehicle data, to provide a function to obtain the standard vehicle data from the standard vehicle data storage unit.
